(19) United States
(12) Patent Application Publication
(10) Pub. No.: US 2006/0092778 A1
(43) Pub. Date: May 4, 2006

(54) Method of detecting focus error signal of optical head and optical recording/reproducing apparatus utilizing the same

(75) Inventors: Giichi Shibuya, Chuo-ku (JP); Teiichiro Oka, Chuo-ku (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/252,810

(22) Filed: Oct. 19, 2005

(30) Foreign Application Priority Data
Oct. 21, 2004 (JP) 2004-307068

(51) Int. Cl. G11B 7/00

(52) U.S. Cl. 369/44.23; 369/44.37

(57) ABSTRACT

The invention relates to a method of detecting a focus error signal of an optical head to be used for controlling the focus position of an objective lens for converging a light beam on an optical recording medium and an optical recording/reproducing apparatus. The invention provides a method of detecting a focus error signal of an optical head which allows a focus error signal to be detected a track cross signal therein attenuated at a plural types of optical recording medium having different physical track pitches and an optical recording/reproducing apparatus employing the method. A light beam emitted by a laser diode is diffracted by a diffraction grating to split it into a main beam and two sub beams of orders of ±1. The main beam and the two sub beams of orders of ±1 are received by three light-receiving elements after being reflected by an optical recording medium, and a focus error signal in which a track cross signal has been attenuated is detected by an error signal detection unit based on electrical signals obtained by photoelectric conversion.

### BACKGROUND OF THE INVENTION

1. Field of the Invention

The present invention relates to a method of detecting a focus error signal of an optical head used for controlling the focal position of an objective lens for converging a light beam on an optical recording medium, and the invention also relates to an optical recording/reproducing apparatus employing the method.

2. Description of Related Art

An optical recording/reproducing apparatus includes an optical head which records information in predetermined regions of a plurality of tracks formed in the radial direction of an optical recording medium so as to extend along the circumferential direction of the optical recording medium that is in the form of, for example, a disk and which reproduces information recording in predetermined regions of the tracks. Optical heads include record-only types used only for recording information on an optical recording medium, reproduction-only types used only for reproducing information, and recording/reproducing types which can be used for both of recording and reproducing. Apparatus loaded with those types of optical heads constitute optical recording apparatus, optical reproducing apparatus, and optical recording/reproducing apparatus, respectively, and all of such apparatus are collectively referred to as optical recording/reproducing apparatus in the present specification.

Astigmatic focus error detection has been frequently used in the related art as a method of detecting a focus error signal (FES) for controlling the focal position of an objective lens used in an optical head provided in an optical recording/reproducing apparatus. Astigmatic focus error detection requires only a simple optical system and allows simple adjustment of an optical axis. However, when compared to other methods of detection, the astigmatic focus error detection has a problem in that a focus error signal is likely to include a track cross signal which is generated when an objective lens moves across a track of an optical recording medium. A technical discussion on this matter is disclosed in Non-Patent Document 1.

The inclusion of a track cross signal in a focus error signal is an important concern for optical recording media employing the land/groove recording method for recording information in both of lands and grooves, in particular, DVD-RAMs which are currently in use. An optical recording medium employing the land/groove recording method has a physical track pitch that is twice a data track pitch, and such a medium will therefore provide a track cross signal having higher contrast when compared to other optical recording medium.

Patent Documents 1 and 2 disclose a differential method for astigmatic focus error detection which makes it possible to eliminate a track cross signal included in a focus error signal. According to the differential astigmatic focus error detection, a light beam emitted by a light source is split into a main beam and a sub beam which are then irradiated on a surface of an optical recording medium. The interval between the spots of the main beam and the sub beam in the radial direction of the optical recording medium surface is set at ½ times the physical track pitch of the medium. A focus error signal is generated according to the astigmatic focus error detection from each of the main beam and the sub beam reflected on the optical recording medium surface, and a focus error signal to be used for focus position control is obtained from the sum of the focus error signals.

Track cross signal components included in the main beam and the sub beam are in phase opposition from each other. The focus error signals of the main beam and the sub beam according to astigmatic focus error detection are generated in the same phase with respect to a focus error. Therefore, only the track cross signal components are eliminated by adding the focus error signal from each of the main beam and the sub beam obtained according to astigmatic focus error detection. As thus described, the differential astigmatic focus error detection is an idealistic method of eliminating track cross signals included in focus error signals. The term “physical track pitch” means a length corresponding to one period of a track cross signal obtained from reproduction using an optical head, and the physical track pitch is twice a data track pitch in DVD-RAMs and is the same length as a data track pitch in other optical recording media including DVD-ROMs.
Patent Document 1: JP-A-4-163681
Patent Document 2: JP-A-11-296875
Patent Document 3: JP-A-10-64104
Non-Patent document 1: SPIE Vol. 1663 Optical Data Storage (1992)/p. 157

In the present field of optical recording/reproducing apparatus which are becoming more and more diversified according to demands in the market, no universal standard has been agreed on optical recording media, and products according to a plurality of standards are therefore being proposed and put in practical use. Under the circumstance, there is sometimes a need for recording and reproducing optical recording media having different physical track pitches using one and the same optical head. FIGS. 15A to 16C schematically show a main beam 101 and sub beams 103a and 103b of orders of ±1 converged on an information recording surface of an optical recording medium. FIGS. 15A and 16A show an information recording surface of a DVD-RAM, FIGS. 15B and 16B show an information recording surface of a DVD-RW and FIG. 15C and FIG. 16C show an information recording surface of DVD-ROM. The arrows R extending in the horizontal direction of FIGS. 15A to 16C represent the radial direction of the optical recording media, and the arrows T extending in the vertical direction of the figures represent a direction tangential to a track of the optical recording media.

As shown in FIGS. 15A and 15B, DVD-RAM and DVD-RW, which are rewritable optical recording media among the family of DVDs, have different physical track pitches P1=1.23 μm and P2=0.74 μm, respectively, the track pitches having influence on a track cross signal. DVD-ROMs, which are used only for reproduction among the DVD family, have a physical track pitch P2=0.74 μm similarly to a DVD-RW.

In order to obtain an idealistic focus error signal by eliminating track cross signals using differential astigmatic focus error detection as described above, each of the intervals between the main beam 101 and the sub beams 103a and 103b in the radial direction must be set at ½ times the physical track pitch. Therefore, in order to obtain an idealistic focus error signal especially from a DVD-RAM on which the mix of track cross signal components is significant, the main beam 101 and the sub beams 103a and 103b are idealistically set at a beam interval BP1 of 0.615 μm.

However, as shown in FIGS. 15B and 15C, the optimum beam interval BP1=0.615 μm of a DVD-RAM does not agree with an optimum beam interval BP2=0.37 μm of a DVD-RW or DVD-ROM. Therefore, a focus error signal detected from the main beam 101 and the sub beams 103a and 103b at the beam interval BP1=0.615 μm using differential astigmatic focus error detection is difficult to use in a DVD-RW.

In an optical head to be used for reproduction only, a differential phase tracking method can be used, in which data of a high frequency (RF signal) is employed to detect a tracking error signal to be used for tracking control of the objective lens. The differential phase tracking method only requires that the optical head accesses a track in which an RF signal is written, and the method utilizes only a main beam and utilizes no sub beam. Thus, sub beams can be used only for generating a differential astigmatic signal from a DVD-RAM. Therefore, the beam interval between the main beam 101 and the sub beams 103a and 103b of the reproduction-only optical head may be set at the optimum beam interval BP1=0.615 μm for a DVD-RAM.

In the case of an optical head used for both recording and reproducing, since the optical head must access even unrecorded regions to perform tracking control of the objective lens, the differential phase tracking method utilizing an RF signal cannot be used. The differential push-pull (DPP) method is preferably used for detecting a tracking error signal to be used for tracking control of an optical head for both recording and reproducing. According to the DPP method, a main beams and sub beams are used for generating a tracking error signal, and an optimum value of the beam interval (spot interval) between those beams in the radial direction of a medium is ½ times the physical track pitch. That is, in the case of an optical head for both recording and reproducing adapted to both of DVD-RAM and DVD-RW which are generally called “super-multi DVDs”, optimum values for positions to which sub beams are to be adjusted are different between the two types of media, and it is therefore difficult for the optical head to satisfactorily work with both types of DVD disk media.

For example, when the spot interval between the main beam 101 and the sub beams 103a and 103b in the radial direction is set at the optimum beam interval BP1 for a DVD-RAM as shown in FIGS. 15A and 15C, the ratio of the beam interval BP1 to the physical track pitch P2 of a DVD-RW is BP1/P2=0.615 μm/0.74 μm=0.831. Since the spot interval BP1 does not agree with ½ times the physical track pitch P2 of a DVD-RW, a track cross signal cannot be satisfactorily eliminated from a focus error signal even when the differential astigmatic focus error detection is used.

When the spot interval between the main beam 101 and the sub beams 103a and 103b in the radial direction is set at the optimum beam interval BP2=0.37 for a DVD-RW as shown in FIGS. 16A and 16B, the ratio of the beam interval BP2 to the physical track pitch P1 of a DVD-RAM is BP2/P1=0.37 μm/1.23 μm=0.300. Since the beam interval BP2 does not agree with ½ times the physical track pitch P1 of a DVD-RAM, a track cross signal cannot be satisfactorily eliminated from a focus error signal even when the differential astigmatic focus error detection is used.

Since the differential astigmatic focus error detection cannot be used for an optical head for both recording and reproducing adapted to both of DVD-RAM and DVD-RW as thus described for detecting a focus error signal, there has been no choice but to use the knife edge method or beam size method which involves a complicated optical system configuration and adjustment.

Patent Document 3 discloses a method of solving the problem that each optical recording medium has different optimum values of sub beam positions because the physical track pitch varies from medium to medium. According to the method, a focus error signal is generated from a signal obtained by adding two sub beams (sub beams of orders of ±1). However, when a focus error signal is generated from sub beams, an unnecessary peak referred to as “a second zero cross signal” as indicated by a in FIG. 17 is likely to occur.

FIG. 17 shows waveforms of focus error signals (S-shaped signal curves) actually measured when an objective lens provided on an optical head is swung. The abscissa axis represents time, and the ordinate axis represents the amplitude of the focus error signals. The plot indicated by A in the figure represents a focus error signal based on a main beam only, and the plot indicated by B in the figure represents a focus error signal based on two sub beams only. The curve of the plot B indicated by α in the figure represents a second zero cross signal which appears in the focus error signal based on sub beams only.

When an S-shaped signal curve including a second zero cross signal of a great magnitude is used to perform a focus leading operation for leading an objective lens into a range in which the focal position can be controlled, it may be impossible to lead the focus of a light beam onto an information recording surface of an optical recording medium properly. Further, the second zero cross signal tends to have a greater magnitude relative to the amplitude of the S-shaped signal curve, the greater the ratio of the luminous energy of the main beam to that of the sub beams. In the measured waveforms shown in FIG. 17, the ratio of the luminous energy of the main beam to that of the sub beams is 8:1, and the luminous energy of one sub beam is 12.5% of the main beam. A focus error signal based on differential astigmatic focus error detection, which has been widely used in the related art, is generated by adding focus error signals based on a main beam and sub beams, respectively. Therefore, a focus error signal according to differential astigmatic focus error detection has a problem in that a second zero cross signal is superimposed.

### SUMMARY OF THE INVENTION

It is an object of the invention to provide a method of detecting a focus error signal of an optical head which allows a focus error signal to be detected while attenuating a track cross signal in the signal on a plurality of optical recording media having different physical track pitches, the invention also providing an optical recording/reproducing apparatus utilizing the method. It is another object of the invention to provide a method of detecting a focus error signal of an optical head which makes it possible to detect a focus error signal for properly leading the focuses of a main beam and two sub beams onto a surface of an optical recording medium when a focus leading operation is performed, the invention also providing an optical recording/reproducing apparatus utilizing the method.

The above-described object is achieved by a method of detecting a focus error signal of an optical head, which comprising the steps of:
diffracting a light beam emitted by a light source to split the beam into a main beam and two sub beams and converging the beams on an optical recording medium through an objective lens;
converting the main beam and the two sub beams reflected by the optical recording medium into electrical signals; and
detecting the focus error signal to be used for adjusting the focal position of the objective lens through an arithmetic process performed by switching a combination of the electrical signal based on the main beam and the electrical signals based on the two sub beams at the time of a focus leading operation for leading the objective lens into a range in which the focal position can be controlled or at the time of a focus follow-up control of the objective lens performed after the focus leading operation.

The invention provides a method of detecting a focus error signal of an optical head according to the above invention, characterized in that the focus error signal is detected by performing an arithmetic process on the electrical signal based on the main beam at the time of the focus leading operation and is detected by performing an arithmetic process on the electrical signals based on the two sub beams at the time of the focus follow-up control.

The invention provides a method of detecting a focus error signal of an optical head according to the above invention, characterized in that:
the focus follow-up control on an optical recording medium (a first optical recording medium) having a physical track pitch P1 is performed by detecting the focus error signal in which a track cross signal generated when the objective lens moves across a track of the first optical recording medium has been attenuated, through an arithmetic process on the electrical signal based on the main beam reflected by the second optical recording medium; and
the focus follow-up control on an optical recording medium (a second optical recording medium) having a physical track pitch P2 (P2<P1) is performed by detecting the focus error signal through an arithmetic process on the electrical signal based on the main beam reflected by the second optical recording medium.

The invention provides a method of detecting a focus error signal of an optical head according to the above invention, characterized in that the focus error signal is detected while adjusting the positions of the spots of the two sub beams without changing the intervals between the main beam and the two sub beams converged on a surface of the first or the second optical recording medium such that one of the two sub beams is positioned at an offset of about +P1×(n+¼) in the radial direction from the position of the spot of the main beam and the other sub beam of the two sub beams is positioned at an offset of about −P1×(n+¼) from the same on the first optical recording medium and such that one of the two sub beams is positioned at an offset of about +P2×(n+½) in the radial direction from the position of the spot of the main beam and the other of the two sub beams is positioned at an offset of about −P2×(n+½) from the same on the second optical recording medium where n represents 0 or a greater integer.

The invention provides a method of detecting a focus error signal of an optical head according to the above invention, characterized in that it comprises the steps of:
receiving one of the two sub beams reflected by the first or the second optical recording medium with a first light-receiving element for sub beams and receiving the other with a second light-receiving element for sub beams;
detecting a first preliminary focus error signal by adding a first sub beam electrical signal output by the first light-receiving element for a sub beam and a second sub beam electrical signal output by the second light-receiving element for a sub beam;
receiving the main beam reflected by the first or the second optical recording medium with a light-receiving element for a main beam;
detecting a second preliminary focus error signal based on a main beam electrical signal output by the light-receiving element for a main beam, wherein the first preliminary focus error signal is selected in the case of the first optical recording medium and the second preliminary focus error signal is selected in the case of the second optical recording medium, respectively, the preliminary focus error signals being detected as the focus error signal.

The invention provides a method of detecting a focus error signal of an optical head according to the above invention, characterized in that, on the first optical recording medium,
a first sub beam addition signal is generated by adding the first sub beam electrical signal output by one of diagonal pairs of light-receiving regions of the first light-receiving element for a sub beam which has four light-receiving regions disposed adjacent to each other in the form of a matrix and the second sub beam electrical signal output by one of diagonal pairs of light-receiving regions of the second light-receiving element for a sub beam which has four light-receiving regions disposed adjacent to each other in the form of a matrix;
a second sub beam addition signal is generated by adding the first sub beam electrical signal output by the other pair of light-receiving regions of the first light-receiving element for a sub beam and the second sub beam electrical signal output by the other pair of light-receiving regions of the second light-receiving element for a sub beam; and
a differential operation is performed on the first and the second sub beam addition signals to generate the first preliminary focus error signal which is then detected as the focus error signal.

The invention provides a method of detecting a focus error signal of an optical head according to the above invention, characterized in that, on the second optical recording medium,
a first main beam addition signal is generated by adding the main beam electrical signals output by one of diagonal pairs of light-receiving regions of the light-receiving element for a main beam which has four light-receiving regions disposed adjacent to each other in the form of a matrix;
a second main beam addition signal is generated by adding the main beam electrical signals output by the other pair of light-receiving regions of the light-receiving element for a main beam; and
a differential operation is performed on the first and the second main beam addition signals to generate the second preliminary focus error signal which is then detected as the focus error signal.

The invention provides a method of detecting a focus error signal of an optical head according to the above invention, characterized in that it comprises the steps of:
receiving one of the two sub beams reflected by the first or the second optical recording medium with a first light-receiving element for sub beams and receiving the other with a second light-receiving element for sub beams;
detecting a first preliminary focus error signal by adding a first sub beam electrical signal output by the first light-receiving element for a sub beam and a second sub beam electrical signal output by the second light-receiving element for a sub beam;
receiving the main beam reflected by the first or the second optical recording medium with a light-receiving element for a main beam; detecting the second preliminary focus error signal based on the main beam electrical signal output from the light receiving element for main beam and
generating a third preliminary focus error signal by adding the first preliminary focus error signal and the second preliminary focus error signal, wherein the second or the third preliminary focus error signal is detected as the focus error signal on the second optical recording medium.

The invention provides a method of detecting a focus error signal of an optical head according to the above invention, characterized in that, on the first optical recording medium,
a first sub beam addition signal is generated by adding the first sub beam electrical signal output by one of diagonal pairs of light-receiving regions of the first light-receiving element for a sub beam which has four light-receiving regions disposed adjacent to each other in the form of a matrix and the second sub beam electrical signal output by one of diagonal pairs of light-receiving regions of the second light-receiving element for a sub beam which has four light-receiving regions disposed adjacent to each other in the form of a matrix;
a second sub beam addition signal is generated by adding the first sub beam electrical signal output by the other pair of light-receiving regions of the first light-receiving element for a sub beam and the second sub beam electrical signal output by the other pair of light-receiving regions of the second light-receiving element for a sub beam; and
a differential operation is performed on the first and the second sub beam addition signals to generate the first preliminary focus error signal which is then detected as the focus error signal.

The invention provides a method of detecting a focus error signal of an optical head according to the above invention, characterized in that, on the second optical recording medium,
a first main beam addition signal is generated by adding the main beam electrical signals output by one of diagonal pairs of light-receiving regions of the light-receiving element for a main beam which has four light-receiving regions disposed adjacent to each other in the form of a matrix;
a second main beam addition signal is generated by adding the main beam electrical signals output by the other pair of light-receiving regions of the light-receiving element for a main beam;
a differential operation is performed on the first and the second main beam addition signals to generate the second preliminary focus error signal; and
the second or the third preliminary focus error signal is detected as the focus error signal on the second optical recording medium.

The invention provides a method of detecting a focus error signal of an optical head according to any of the above invention, characterized in that the diameter of the spots of the two sub beams formed on a surface of the optical recording medium in the radial direction of the optical recording medium is 2.5 times or more of the diameter of the spot of the main beam in the same direction and wherein an arithmetic process is performed on the electrical signal based on the two sub beams reflected on the surface of the optical recording medium to detect the focus error signal in which the track cross signal has been attenuated.

The above-described object is achieved by an optical recording/reproducing apparatus wherein it comprises:
an optical head including a diffraction grating for diffracting a light beam emitted by a light source to emit a main beam and two sub beams, an objective lens for converging the main beam and the two sub beams on an optical recording medium, and a light-receiving element for receiving each of the main beam and the two sub beams reflected by the optical recording medium and for converting each beam into an electrical signal; and
an error signal detection unit for generating a focus error signal to be used for adjusting the focal position of the objective lens through an arithmetic process performed by switching the combination of the electrical signal based on the main beam and the electrical signals based on the two sub beams at the time of a focus leading operation for leading the objective lens into a range in which the focal position can be controlled or a focus follow-up control of the objective lens performed after the focus leading operation.

The invention provides an optical recording/reproducing apparatus according to the above invention, characterized in that the error signal detection unit detects the focus error signal obtained by performing an arithmetic process on the electrical signal based on the main beam at the time of the focus leading operation and detects the focus error signal obtained by performing an arithmetic process on the electrical signals based on the two sub beams at the time of the focus follow-up control.

The invention provides an optical recording/reproducing apparatus according to the above invention, characterized in that:
when the focus follow-up control is performed on an optical recording medium (first optical recording medium) having a physical track pitch P1, the error signal detection unit detects the focus error signal in which a track cross signal generated when the objective lens moves across a track of the first optical recording medium has been attenuated, by performing an arithmetic process on the electrical signal based on the two sub beams reflected by the first optical recording medium; and
when the focus follow-up control is performed on an optical recording medium (second optical recording medium) having a physical track pitch P2 (P2<P1), the error signal detection unit detects the focus error signal by performing an arithmetic process on the electrical signal based on the main beam reflected by the second optical recording medium.

The invention provides an optical recording/reproducing apparatus according to the above invention, characterized in that the error signal detection unit includes a switch which is controlled such that the focus error signal obtained by performing an arithmetic process on the electrical signal based on the two sub beams is selected for the first optical recording medium and such that the focus error signal obtained by performing an arithmetic process on the electrical signal based on the main beam is selected for the second optical recording medium.

The invention provides an optical recording/reproducing apparatus according to the above invention, characterized in that the switch is controlled such that the focus error signal obtained by performing an arithmetic process on the electrical signal based on the main beam reflected by the first or the second optical recording medium is output to perform the focus leading operation and such that the focus error signal obtained by performing an arithmetic process on the electrical signal based on the two sub beams reflected by the first optical recording medium is selected for the first optical recording and the focus error signal obtained by performing an arithmetic process on the electrical signal based on the main beam reflected by the second optical recording medium is selected for the second optical recording medium to effect the focus follow-up control.

The invention provides an optical recording/reproduction apparatus according to of the above invention, characterized in that the light-receiving elements comprises a light-receiving element for a main beam which has four light-receiving regions disposed adjacent to each other in the form of a matrix and which receives the main beam reflected by the first or the second optical recording medium, a first light-receiving element for a sub beam which has four light-receiving regions disposed adjacent to each other in the form of a matrix and which receives one of the two sub beams reflected by the first or second optical recording medium, and a second light-receiving element for a sub beam which has four light-receiving regions disposed adjacent to each other in the form of a matrix and which receives the other of the two sub beams reflected by the first or the second optical recording medium.

The invention provides an optical recording/reproducing apparatus according to the above invention, characterized in that the error signal detection unit detects the focus error signal in which the track cross signal has been attenuated based on a first sub beam electrical signal output by the first light-receiving element for a sub beam and a second sub beam electrical signal output by the second light-receiving element for a sub beam on the first optical recording medium and detects the focus error signal based on a main beam electrical signal output by the light-receiving element for a main beam on the second optical recording medium.

The invention provides an optical recording/reproducing apparatus according to the above invention, characterized in that the focus error signal in which the track cross signal has been attenuated is detected while adjusting the positions of the spots of the two sub beams without changing the spot intervals between the main beam and the two sub beams converged on a surface of the first or the second optical recording medium such that one of the two sub beams is positioned at an offset of about +P1×(n+¼) in the radial direction from the position of the spot of the main beam and the other sub beam is positioned at an offset of about −P1×(n+¼) from the same on the first optical recording medium and such that one of the two sub beams is positioned at an offset of about +P2×(n+½) in the radial direction from the position of the spot of the main beam and the other sub beam is positioned at an offset of about −P2×(n+½) from the same on the second optical recording medium where n represents 0 or a greater integer.

The invention provides an optical recording/reproducing apparatus according to the above invention, characterized in that the error signal detection unit includes a first preliminary focus error signal detecting portion which detects a first preliminary focus error signal that is the electrical signals based on the two sub beams reflected by the first or the second optical recording medium, having:
a first adding part for adding the first sub beam electrical signal output by one of the diagonal pairs of light-receiving regions of the first light-receiving element for a sub beam and the second sub beam electrical signal output by one of the diagonal pairs of light-receiving regions of the second light-receiving element for a sub beam;
a second adding part for adding the first sub beam electrical signal output by the other pair of light-receiving regions of the first light-receiving element for a sub beam and the second sub beam electrical signal output by the other pair of light-receiving regions of the second light-receiving element for a sub beam; and
a first differential operation part for performing a differential operation on electrical signals output by the first and the second adding parts, respectively.

The invention provides an optical recording/reproducing apparatus according to the above invention, characterized in that the error signal detection unit includes a second preliminary focus error signal detecting portion which detects second preliminary focus error signal that is the electrical signal based on the main beam reflected by the first or the second optical recording medium, having:
a third adding part for adding the main beam electrical signals output by the other diagonal pairs of light-receiving regions of the light-receiving element for a main beam; a fourth adding part for adding the main beam electrical signals output from the other pair of light-receiving regions of the light-receiving element for the main beam; and
a second differential operation part for performing a differential operation on electrical signals output by the third and fourth adding parts, respectively.

The invention provides an optical recording/reproducing apparatus according to the above invention, characterized in that the error signal detection unit further includes a third preliminary focus error detecting portion which detects a third preliminary focus error signal by adding the first and the second preliminary focus error signals, having a preliminary focus error signal adding portion for adding the first preliminary focus error signal output by the first preliminary focus error signal detecting portion and the second preliminary focus error signal output by the second preliminary focus error signal detecting portion.

The invention provides an optical recording/reproducing apparatus according to the above invention, characterized in that the switch is controlled so as to select the first preliminary focus error signal in the case of the first optical recording medium and to select the second or the third preliminary focus error signal in the case of the second optical recording medium as the focus error signal.

The invention provides an optical recording/reproducing apparatus according to the above invention, characterized in that the diameter of the spots of the two sub beams formed on a surface of the optical recording medium in the radial direction of the optical recording medium is 2.5 times or more of the diameter of the spot of the main beam in the same direction.

The invention provides an optical recording/reproducing apparatus according to the above invention, characterized in that the first optical recording medium is a DVD-RAM or an optical recording medium having a physical track pitch equivalent to that of the DVD−RAM and wherein the second optical recording medium is a DVD±R/RW, DVD−ROM or an optical recording medium having a physical track pitch equivalent to that of the DVD±R/RW or DVD−ROM.

The invention makes it possible to provide an optical recording/reproducing apparatus which is capable of detecting a focus error signal in which a track cross signal has been attenuated from a plural types of optical recording media having different physical track pitches.

The invention also makes it possible to provide an optical recording/reproducing apparatus which is capable of detecting a focus error signal for leading the focuses of a main beam and two sub beams onto a surface of an optical recording medium properly when a focus leading operation is performed from a plural types of optical recording media having different physical track pitches.

### BRIEF DESCRIPTION OF THE DRAWINGS

FIG. 1 shows a schematic configuration of an optical head 1 of a first embodiment of the invention;

FIGS. 2A, 2B, and 2C schematically show states of light beams converged on information recording surfaces of optical recording media 15 used with the optical head 1 of the first embodiment of the invention;

FIG. 3 shows a configuration of light-receiving portions of light-receiving elements 23, 25a, and 25b of the optical head 1 and connections between the light-receiving elements 23, 25a, and 25b and an error signal detecting unit 31 in the first embodiment of the invention;

FIG. 4 shows an FES detection circuit provided in the error signal detection unit 31 of an optical recording/reproducing apparatus 150 of the first embodiment of the invention;

FIG. 5 shows a TES detection circuit provided in the error signal detection unit 31 of an optical recording/reproducing apparatus 150 of the first embodiment of the invention;

FIGS. 6A and 6B are graphs for explaining optimization of the intervals of spots of a main beam 27 and sub beams 29a and 29b of orders of ±1 from the optical head 1 of the first embodiment of the invention, the graphs showing waveforms of focus error signals obtained when the main beam and the sub beams of orders of ±1 are focused on an information recording surface of an unrecorded DVD−RAM;

FIGS. 7A and 7B are illustrations for explaining optimization of the intervals of spots of the main beam 27 and the sub beams 29a and 29b of orders of ±1 from the optical head 1 of the first embodiment of the invention, the illustrations showing states of the main beam 27 converged on the light-receiving element 23;

FIG. 8 is a graph for explaining optimization of the intervals of spots of the main beam 27 and the sub beams 29a and 29b of orders of ±1 from the optical head 1 of the first embodiment of the invention, the graph showing a result of a simulation in which states of track cross signals included in the main beam and the sub beams are calculated using the scalar diffraction theory;

FIG. 9 is a graph for explaining optimization of the intervals of spots of the main beam 27 and the sub beams 29a and 29b of orders of ±1 from the optical head 1 of the first embodiment of the invention, the graph showing changes in the amplitude of a track cross signal included in a sub beam with respect to the interval between the spots of the main beam and the sub beam in the radial direction of the optical recording medium;

FIGS. 10A and 10B are tables for explaining optimization of the intervals of spots of the main beam 27 and the sub beams 29a and 29b of orders of ±1 from the optical head 1 of the first embodiment of the invention, the tables showing the physical track pitches of DVD−RAM and DVD±R/RW and optimum values of the interval between spots of a main beam and a sub beam when differential astigmatic focus error detection is used;

FIG. 11 shows a schematic configuration of the optical recording/reproducing apparatus 150 of the present embodiment;

FIG. 12 schematically shows state of light beams converged on information recording surfaces of optical recording media 15a used with the optical head of a second embodiment of the invention;

FIG. 13 shows results of measurement on focus error signals obtained using an optical head according to the second embodiment of the invention according to astigmatic focus error detection based on reflected light from a DVD−RAM (first optical recording medium 15a);

FIG. 14 shows a comparison between the amplitudes of track cross signal components included in focus error signals obtained using the optical head of the second embodiment and optical heads according to the related art;

FIGS. 15A, 15B, and 15C schematically show light beams converged on an information recording surface of an optical recording medium to be used with an optical head according to the related art;

FIGS. 16A, 16B, and 16C schematically show light beams converged on an information recording surface of an optical recording medium to be used with an optical head according to the related art; and

FIG. 17 shows waveforms of focus error signals (S-shaped signal curves) measured when an objective lens provided on an optical head according to the related art is swung.

### DESCRIPTION OF THE PREFERRED EMBODIMENTS

### FIRST EMBODIMENT

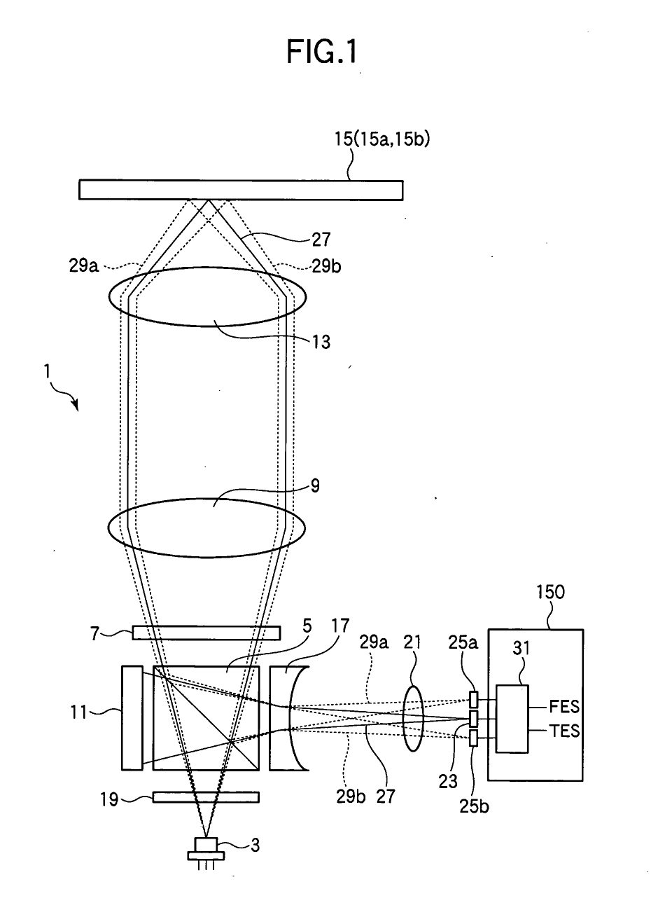

A description will now be made with reference to FIGS. 1 to 11 on a method of detecting a focus error signal from an optical head and an optical recording/reproducing apparatus utilizing the method according to a first embodiment of the invention. A schematic configuration of an optical head 1 provided in an optical recording/reproducing apparatus 150 according to the present embodiment will be first described with reference to FIGS. 1 to 5. The optical head 1 of the present embodiment allows information to be recorded or reproduced on or from each of two types of optical recording media 15 having different physical track pitches. One of the optical recording media 15 (first optical recording medium 15a) which has a relatively great physical track pitch is a DVD−RAM or an optical recording medium equivalent to a DVD−RAM in physical track pitch. The other optical recording medium 15 (second optical recording medium 15b) which has a relatively small physical track pitch is a DVD−ROM or DVD±R/RW or an optical recording medium equivalent to them in physical track pitch. The first optical recording medium 15a has a physical track pitch P1 of 1.23 μm, and the second optical recording medium 15b has a physical track pitch P2 of 0.74 μm.

As shown in FIG. 1, the optical head 1 includes a laser diode 3 as a light source that emits light beams. The laser diode 3 can emit light beams having different optical intensities for recording and reproduction, respectively, based on control voltages from a controller (not shown).

A diffraction grating 19 is disposed in a predetermined position on a light exit side of the laser diode 3. A light beam emitted by the laser diode 3 enters the diffraction grating 19 and the light beam split into three light beams (a zero order main beam 27 and sub beams 29a and 29b of orders of ±1). The sub beams 29a and 29b of orders of ±1 are located on a surface (information recording surface) of the optical recording medium 15 at a predetermined distance from each other in the direction of a track in a symmetrical relationship about the position of the main beam 27.

A polarization beam splitter 5, a quarter-wave plate 7, a collimator lens 9, and an objective lens 13 are disposed on a light-transmitting side of the diffraction grating 19 as viewed from the laser diode 3, the elements being listed in the order of their closeness to the diffraction grating. The collimator lens 9 is provided to convert a divergent bundle of rays from the laser diode 3 into a parallel pencil of rays which is then guided to the objective lens 13 and to convert a parallel pencil of rays from the objective lens 13 into a convergent pencil of rays which is then guided to light-receiving elements 23, 25a and 25b. The objective lens 13 converges a parallel pencil of rays from the collimator lens 9 on the information recording surface of the optical recording medium 15 to form a read spot, and the lens is also provided to convert reflected light from the optical recording medium 15 into a parallel pencil of rays which is then guided to the collimator lens 9.

A sensor lens 17, a cylindrical lens 21, and light-receiving elements 23, 25a, and 25b are disposed on a light-reflecting side of the polarization beam splitter 5 as viewed from the quarter-wave plate 7, the elements being listed in the order of their closeness to the beam splitter. A power-monitoring photodiode 11 for measuring the optical intensity of a light beam emitted by the laser diode 3 is disposed on a light-reflecting side of the polarization beam splitter 5 as viewed from the laser diode 3.

The sensor lens 17 serves as a reflected light focusing position adjusting portion for optically adjusting focusing positions of the main beam 27 and the sub beams 29a and 29b of orders of ±1 reflected by the optical recording medium 15. The sensor lens 17 expands the main beam 27 and the sub beams 29a and 29b of orders of ±1 reflected by the optical recording medium 15 at a predetermined optical magnification and forms their images separately on the light-receiving elements 23, 25a, and 25b, respectively, through the cylindrical lens 21. The light-receiving element (main beam receiving element) 23 receives the main beam 27. The light-receiving element (first sub-beam receiving element) 25a receives the sub beam 29a of order of ±1. The light-receiving element (second sub-beam receiving element) 25b receives the sub beam 29b of order of −1. A main beam electrical signal and first and second sub beam electrical signals obtained as a result of photoelectrical conversion at the light-receiving elements 23, 25a, and 25b are input to an error signal detecting unit 31 provided in the optical recording/reproducing apparatus 150. The error signal detecting unit 31 performs arithmetic processes on the first and the second sub beam electrical signals based on the sub beams 29a and 29b of orders of +1 reflected by the optical recording medium 15 and detects a focus error signal (FES) in which a track cross signal generated by a movement of the objective lens 13 across a track of the optical recording medium 15 has been attenuated. The error signal detecting unit 31 also performs arithmetic processes on the main beam electrical signal and the first and the second sub beam electrical signals and detects a tracking error signal (TES).

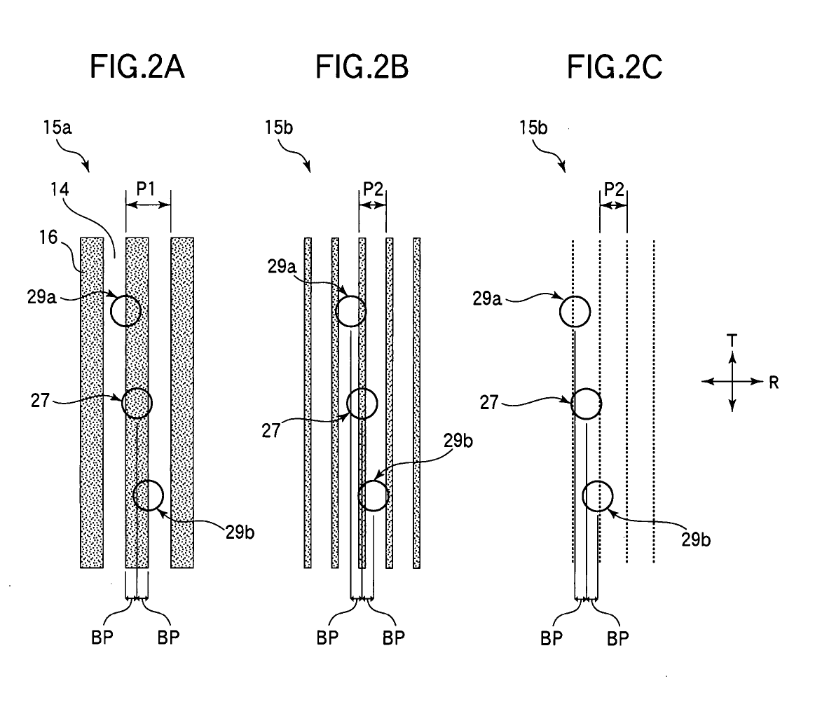

FIGS. 2A, 2B, and 2C schematically show states of the main beam 27 and the sub beams 29a and 29b of orders of +1 converged on information recording surfaces of optical recording media 15. FIG. 2A shows an information recording surface of a DVD−RAM serving as the first optical recording medium 15a. FIG. 2B shows an information recording surface of a DVD−RW serving as the second optical recording medium 15b. FIG. 2C shows an information recording surface of a DVD−ROM serving as the second optical recording medium 15b. The arrow R in the horizontal direction of the figures represents the radial direction of the first and the second optical recording media 15a and 15b, and the arrow T in the vertical direction represents a direction tangential to the first and the second optical recording media 15a and 15b.

As shown in FIGS. 2A, 2B, and 2C, a spot interval BP of the main beam 27 and the sub beams 29a and 29b of orders of ±1 in the radial direction is adjusted to 0.307 μm on either of the first and the second optical recording media 15a and 15b. The ratio of the spot interval BP to the physical track pitch P1 of the first optical recording medium 15a is 0.307 μm/1.23 μm=0.249. On the first optical recording medium 15a, the sub beam 29a of order of ±1 and the sub beam 29b of order of −1 are adjusted to be in positions shifted from the position of the spot of the main beam 27 by approximate amounts of +P1×(n+¼)=+P¼ and −P1×(n+¼)=−P¼ in the radial direction of the medium, respectively, where n=0.

The ratio of the spot interval BP to the physical track pitch P2 of the second optical recording medium 15b is 0.307 μm/0.74 μm=0.415. On the second optical recording medium 15b, the sub beam 29a of order of ±1 and the sub beam 29b of order of −1 are adjusted to be in positions shifted from the position of the spot of the main beam 27 by approximate amounts of +P2×(n+½)=+P2/2 and −P2×(n+½)=−P2/2 in the radial direction of the medium, respectively, where n=0.

Thus, the spot interval BP is substantially ¼ times the pitch P1 of the first optical recording medium 15a (n=0) and is substantially ½ times the pitch P2 of the second optical recording medium 15b (n=0) where n is 0 or greater integer. For example, the interval between the main beam 27 and the sub beams 29a and 29b of orders of +1 in the radial direction is adjusted by rotating a grating surface of the diffraction grating 19 about the optical axis of the diffraction grating 19.

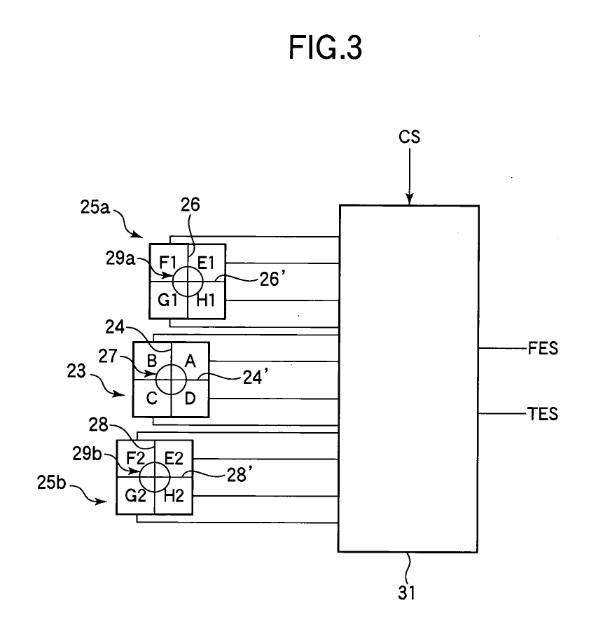

FIG. 3 shows a configuration of light-receiving portions of the light-receiving elements 23, 25a, and 25b and connections between the light-receiving elements 23, 25a, and 25b and the error signal detecting unit 31. As shown in FIG. 3, a square light-receiving area of the light-receiving element 23 is divided by a division line 24 that is substantially in parallel with a direction tangential to the tracks of the optical recording medium 15 (not shown in FIG. 3) and a division line 24′ that is substantially orthogonal to the division line 24. Thus, the element has four square light-receiving regions A, B, C, and D disposed adjacent to each other in the form of a matrix. The light-receiving region A is disposed such that it adjoins the light-receiving region B through the division line 24 and the light-receiving region D through the division line 24′, and such that it is located diagonally to the light-receiving region C. The light-receiving region C is disposed such that it adjoins the light-receiving region D through the division line 24 and the light-receiving region B through the division line 24′.

Similarly, a square light-receiving area of the light-receiving element 25a is divided by a division line 26 that is substantially in parallel with the direction tangential to the tracks of the optical recording medium 15 and a division line 26′ that is substantially orthogonal to the division line 26. Thus, the element has four square light-receiving regions E1, F1, G1, and H1 disposed adjacent to each other in the form of a matrix. The light-receiving region E1 is disposed such that it adjoins the light-receiving region F1 through the division line 26 and the light-receiving region H1 through the division line 26′, and such that it is located diagonally to the light-receiving region G1. The light-receiving region G1 is disposed such that it adjoins the light-receiving region H1 through the division line 26 and the light-receiving region F1 through the division line 26′.

Similarly, a square light-receiving area of the light-receiving element 25b is divided by a division line 28 that is substantially in parallel with the direction tangential to the tracks of the optical recording medium 15 and a division line 28′ that is substantially orthogonal to the division line 28. Thus, the element has four square light-receiving regions E2, F2, G2, and H2 disposed adjacent to each other in the form of a matrix. The light-receiving region E2 is disposed such that it adjoins the light-receiving region F2 through the division line 28 and the light-receiving region H2 through the division line 28′, and such that it is located diagonally to the light-receiving region G2. The light-receiving region G2 is disposed such that it adjoins the light-receiving region H2 through the division line 28 and the light-receiving region F2 through the division line 28′.

The light-receiving elements 23, 25a, and 25b are slightly offset from each other in the radial direction of the medium to accommodate offsets of optical paths attributable to differences of the positions of spots formed by the main beam 27 and the sub beams 29a and 29b of orders of ±1 on the information recording surface of the optical recording medium 15. One wiring extended from each of the light-receiving regions A to D, E1 to H1, and E2 to H2 is connected to the error signal detection unit 31. The error signal detection unit 31 detects a focus error signal and a tracking error signal by performing predetermined arithmetic operations on the main beam electrical signal and the first and the second sub beam electrical signals output from the light-receiving regions A to D, E1 to H1, and E2 to H2.

A control signal CS is input to the error signal detection unit 31. At the error signal detection unit 31, the combination of arithmetic processes of the main beam electrical signal and the first and the second sub beam electrical signals is switched based on the control signal CS at the time of a focus leading operation for the objective lens or at the time of a focus follow-up operation for the objective lens. When the focus follow-up operation for the objective lens 13 is performed, the error signal detection unit 31 performs by switching the combination of arithmetic operations of the main beam electrical signal or the first and the second sub beam electrical signals based on the control signal CS to deal with the first or the second optical recording media 15a or 15b.

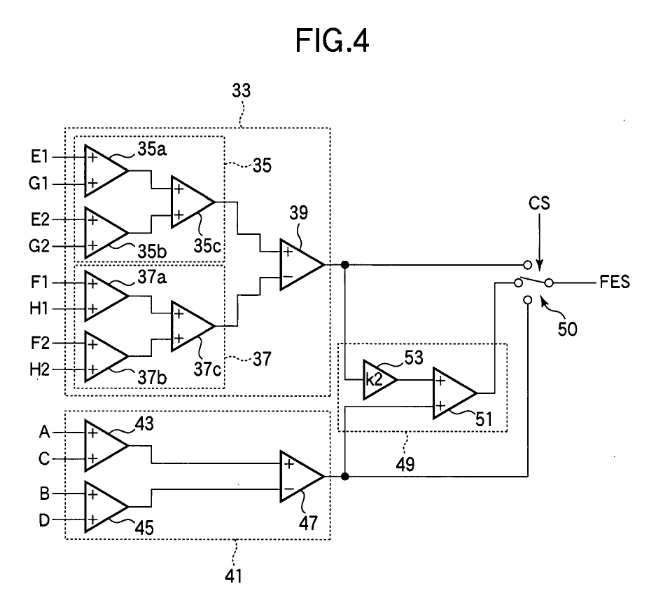

FIG. 4 shows an FES detection circuit provided in the error signal detection unit 31. The FES detection circuit includes a first preliminary focus error signal detecting portion 33 for detecting a first preliminary focus error signal PFES1 using the first and the second sub beam electrical signals output by the light-receiving elements 25a and 25b, a second preliminary focus error signal detecting portion 41 for detecting a second preliminary focus error signal PFES2 using the main beam electrical signal output by the light-receiving element 23, and a third preliminary focus error signal detecting portion 49 for detecting a third preliminary focus error signal PFES3 using the first and the second preliminary focus error signals PFES1 and PFES2. Further, the FES detection circuit includes a switch 50 which is switched under control of the control signal CS. When the focus leading operation for the objective lens 13 is performed, the switch 50 is controlled to select the second preliminary focus error signal PFES2. When the focus follow-up operation for the objective lens 13 that follows the focus leading operation is performed, the switch 50 is controlled to select the first preliminary focus error signal PFES1 as a focus error signal in the case of the first optical recording medium 15a and to select the second or the third preliminary focus error signal PFES2 or PFES3 as a focus error signal in the case of the second optical recording medium 15b.

The first preliminary focus error signal detecting portion 33 includes first and second adding parts 35 and 37 and a first differential operation part 39. The first adding part 35 includes three adders 35a, 35b, and 35c. The adders 35a, 35b, and 35c have a circuit configuration with two inputs and one output. The two input terminals (+) of the adder 35a are connected to the light-receiving regions E1 and G1 of the light-receiving element 25a respectively. The output terminal of the adder 35a is connected to one of the input terminals (+) of the adder 35c. The two input terminals (+) of the adder 35b are connected to the light-receiving regions E2 and G2 of the light-receiving element 25b, respectively. The output terminal of the adder 35b is connected to the other input terminal (+) of the adder 35c. The output terminal of the adder 35c is connected to a non-inverting input terminal (+) of the first differential operation part 39.

The first adding part 35 has a function of adding the first and the second sub beam electrical signals output by one of the diagonal pairs of light-receiving regions of the light-receiving element 25a, i.e., the regions E1 and G1 and one of the pairs of light-receiving regions of the light-receiving element 25b, i.e., the regions E2 and G2. A first sub beam addition signal output by the first adding part 35 can be expressed as follows.
E1+G1+E2+G2=E+G Expression 1
In Expression 1, E1+E2=E, and G1+G2=G.

The second adding part 37 includes three adders 37a, 37b, and 37c. The adders 37a, 37b, and 37c have a circuit configuration with two inputs and one output. The two input terminals (+) of the adder 37a are connected to the light-receiving regions F1 and H1 of the light-receiving element 25a respectively. The output terminal of the adder 37a is connected to one of the input terminals (+) of the adder 37c. The two input terminals (+) of the adder 37b are connected to the light-receiving regions F2 and H2 of the light-receiving element 25b respectively. The output terminal of the adder 37b is connected to the other input terminal (+) of the adder 37c. The output terminal of the adder 37c is connected to an inverting input terminal (−) of the first differential operation part 39.

The second adding part 37 has a function of adding the first and the second sub beam electrical signals output by the other diagonal pair of light-receiving regions of the light-receiving element 25a, i.e., the regions F1 and H1 and the other pair of light-receiving regions of the light-receiving element 25b, i.e., the regions F2 and H2. A second sub beam addition signal output by the second adding part 37 can be expressed as follows.
F1+H1+F2+H2=F+H Expression 2
In Expression 2, F1+F2=F, and H1+H2=H.

The first differential operation part 39 similarly has a circuit configuration with two inputs and one output. The first differential operation part 39 has a function of performing a differential operation on the electrical signals E+G and F+H output by the first and the second adding parts 35 and 37, respectively. The first preliminary focus error signal PFES1 output by the first differential operation part 39 can be expressed as follows.
PFES1=(E+G)−(F+H) Expression 3

As will be detailed later, when the light-receiving elements 23, 25a, and 25b receive reflected light from the first optical recording medium 15a on which the spot interval BP of the main beam 27 and the sub beams 29a and 29b of orders of ±1 is substantially ¼ times the physical track pitch of the medium, the first preliminary focus error detecting portion 33 (the first differential operation part 39) outputs a first preliminary focus error signal PFES1 in which track cross signals have been attenuated. When the light-receiving elements 23, 25a, and 25b receive reflected light from the second optical recording medium 15b on which the spot interval of the beams 27, 29a and 29b is substantially ½ times the physical track pitch of the medium, the first preliminary focus error detecting portion 33 outputs a first preliminary focus error signal PFES1 in which track cross signals have not been attenuated.

The second preliminary focus error signal detecting portion 41 includes third and fourth adding parts 43 and 45 and a second differential operation part 47. The third adding part 43 has a circuit configuration with two inputs and one output. The two input terminals (+) of the third adding part 43 are connected to the light-receiving regions A and C of the light-receiving element 23 respectively. The output terminal of the third adding part 43 is connected to a non-inverting input terminal (+) of the second differential operation part 47. The third adding part 43 has a function of adding main beam electrical signals output by one of the diagonal pairs of light-receiving regions of the light-receiving element 23, i.e., the regions A and C. A first main beam addition signal output by the third adding part 43 can be expressed as follows.
A+C Expression 4

The fourth adding part 45 similarly has a circuit configuration with two inputs and one output. The two input terminals (+) of the fourth adding part 45 are connected to the light-receiving regions B and D of the light-receiving element 23 respectively. The output terminal of the fourth adding part 45 is connected to an inverting input terminal (−) of the second differential operation part 47. The fourth adding part 45 has a function of adding main beam electrical signals output by the other diagonal pair of light-receiving regions of the light-receiving element 23, i.e., the regions B and D. A second main beam addition signal output by the fourth adding part 45 can be expressed as follows.
B+D Expression 5

The second differential operation part 47 also has a similar circuit configuration with two inputs and one output. The second differential operation part 47 has a function of performing a differential operation on the first and the second main beam addition signals A+C and B+D output by the third and the fourth adding parts 43 and 45, respectively. Therefore, a second preliminary focus error signal PFES2 output by the second differential operation part 47 can be expressed as follows.
PFES2=(A+C)−(B+D) Expression 6

Expression 6 is similar to an arithmetic expression used in astigmatic focus error detection according to the related art. Therefore, the second preliminary focus error detecting portion 41 has a function similar to astigmatic FES detection in the related art.

The third preliminary focus error signal detecting portion 49 includes a preliminary focus error signal adding part 51 and a signal amplification part 53. An input terminal of the signal amplification part 53 is connected to the output terminal of the first differential operation part 39, and an output terminal of the same is connected to one input terminal (+) of the preliminary focus error adding part 51. The signal amplification part 53 has a function of amplifying the first preliminary focus error signal PFES1 by a factor of k1. An electrical signal output by the signal amplification part 53 can be expressed as follows.
k1×{(E+G)−(F+H)} Expression 7

Where the coefficient k1 is a coefficient which can be either positive or negative.

The output terminal of the second differential operation part 47 is connected to another input terminal (+) of the preliminary focus error signal adding part 51. The preliminary focus error signal adding part 51 has a function of adding the first preliminary focus error signal PFES1 amplified by a factor of k1 and output by the signal amplification part 53 and the second preliminary focus error signal PFES2 output by the second differential operation part 47. A third preliminary focus error signal PFES3 output by the preliminary focus error signal adding part 51 can be expressed as follows.
PFES3={(A+C)−(B+D)}+k1×{(E+G)−(F+H)} Expression 8

Expression 8 is similar to an arithmetic expression used in differential astigmatic focus error detection in the related art. Therefore, the third preliminary focus error signal detecting portion 49 has a function similar to differential astigmatic FES detection in the related art. Track cross signal components included in the main beam 27 and sub beams 29a and 29b of orders of ±1 are in phase opposition from each other. Therefore, the sub beams 29a and 29b of orders of ±1 multiplied by the predetermined value k1 are added to the main beam 27 as shown in Expression 8, which allows the preliminary focus error signal PFES3 to be generated with track cross signal components therein attenuated.

The switch 50 has a circuit configuration with three inputs and one output. An output terminal of the first preliminary focus error signal detecting portion 33 (the first differential operation part 39), an output terminal of the second preliminary focus error signal detecting portion 41 (the second differential operation part 47), and an output terminal of the third preliminary focus error signal detecting portion 49 (the preliminary focus error signal adding part 51) are connected to respective ones of the three input terminals of the switch 50. The switch 50 is controlled to select the second preliminary focus effort signal PFES2 when the focus leading operation for the objective lens 13 is performed. When the focus follow-up operation for the objective lens 13 such as focus position control is performed after the focus leading operation, the switch 50 is controlled to select the first preliminary focus error signal PFES1 as a focus error signal in the case of the first optical recording medium 15a and to select, for example, the third preliminary focus error signal PFES3 in the case of the second optical recording medium 15b. At the error signal detection unit 31, the switch 50 is switched according to the physical track pitch of the optical recording medium 15 and either the first preliminary focus error signal PFES1 or the third preliminary focus error signal PFES3 are detected as a focus error signal.

As thus described, the error signal detection unit 31 can detect the first preliminary focus error signal PFES1 in which track cross signals have been attenuated as a focus error signal when the light-receiving elements 23, 25a, and 25b receive reflected light from the first optical recording medium 15a, and the unit can detect the third preliminary focus error signal PFES3 in which track cross signals have been attenuated as a focus error signal when the light-receiving elements 23, 25a, and 25b receive reflected light from the second optical recording medium 15b. Therefore, the optical recording/reproducing apparatus 150 having the optical head 1 and the error signal detection unit 31 can detect a focus error signal in which track cross signals have been attenuated from either of the first and the second optical recording media 15a and 15b.

In the case of the second optical recording medium 15b, the switch 50 of the error signal detection unit 31 may be controlled to detect the second preliminary focus error signal PFES2 as a focus error signal instead of the third preliminary focus error signal PFES3. The second preliminary focus error signal PFES2 has a problem in that it is more vulnerable to the entry of track cross signals than the third preliminary focus error signal PFES3. However, the signal PFES2 is advantageous in reducing the cost of the optical head 1 because there is no need for providing the third preliminary focus error signal detecting portion 49 in the error signal detection unit 31.

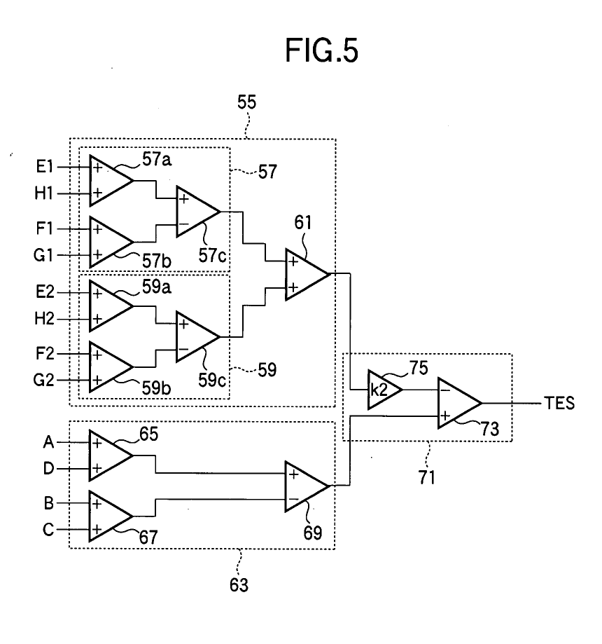

FIG. 5 shows a TES detection circuit provided in the error signal detection unit 31. In the present embodiment, the differential push-pull method is used for detecting a tracking error signal. The TES detection circuit is used commonly for the first and the second optical recording media 15a and 15b. As shown in FIG. 5, the TES detection circuit has a first preliminary tracking error signal detecting portion 55 for detecting a first preliminary tracking error signal using the first and the second sub beam electrical signals output by the light-receiving elements 25a and 25b, and a second preliminary tracking error signal detecting portion 63 for detecting a second preliminary tracking error signal using the main beam electrical signal output by the light-receiving element 23, and a TES generating portion 71 for generating a tracking error signal using the first and the second preliminary tracking error signals.

The first preliminary tracking error signal detecting portion 55 includes first and second differential operation parts 57 and 59 and a first adding part 61. The first differential operation part 57 includes adding parts 57a and 57b and a differential part 57c. The adding parts 57a and 57b and the differential part 57c have a circuit configuration with two inputs and one output. The two input terminals (+) of the adding part 57a are connected to the light-receiving regions E1 and H1 of the light-receiving element 25a, respectively. The output terminal of the adding part 57a is connected to a non-inverting input terminal (+) of the differential part 57c. The two input terminals (+) of the adding part 57b are connected to the light-receiving regions F1 and G1 of the light-receiving element 25a, respectively. The output terminal of the adding part 57b is connected to an inverting input terminal (−) of the differential part 57c. The output terminal of the differential part 57c is connected to one of the input terminals (+) of the first adding part 61.

The first differential operation part 57 has a function of performing a differential operation on the first sub beam electrical signals output by respective pairs of light-receiving regions of the light-receiving element 25a divided by the division line 26, i.e., regions E1 and H1 and regions F1 and G1. An electrical signal output by the first differential operation part 57 can be expressed as follows.
(E1+H1)−(F1+G1) Expression 9

The second differential operation part 59 includes adding parts 59a and 59b and a differential part 59c. The adding parts 59a and 59b and the differential part 59c have a circuit configuration with two inputs and one output. The two input terminals (+) of the adding part 59a are connected to the light-receiving regions E2 and H2 of the light-receiving element 25b respectively. The output terminal of the adding part 59a is connected to a non-inverting input terminal (+) of the differential part 59c. The two input terminals (+) of the adding part 59b are connected to the light-receiving regions F2 and G2 of the light-receiving element 25b respectively. The output terminal of the adding part 59b is connected to an inverting input terminal (−) of the differential part 59c. The output terminal of the differential part 59c is connected to the other input terminal (+) of the first adding part 61.

The second differential operation part 59 has a function of performing a differential operation on the second sub beam electrical signals output by the respective pairs of light receiving regions of the light-receiving element 25b divided by the division line 28, i.e., the regions E2 and H2 and the regions F2 and G2. An electrical signal output by the second differential operation part 59 can be expressed as follows.
(E2+H2)−(F2+G2) Expression 10

The first adding part 61 also has a circuit configuration with two inputs and one output. The first adding part 61 has a function of adding the electrical signals (E1+H1)−(F1+G1) and (E2+H2)−(F2+G2) output by the first and the second differential operation parts 57 and 59, respectively. Therefore, a first preliminary tracking error signal PTES1 output by the first adding part 61 can be expressed as follows.
PTES1={(E1+H1)−(F1+G1))+{E2+H2}−(F2+G2)}=(E+H)−(F+G) Expression 11

In Expression 11, E1+E2=E; F1+F2=F; G1+G2=G; and H1+H2=H.

The second preliminary tracking error signal detection portion 63 includes second and third adding parts 65 and 67 and a third differential operation part 69. The second and the third adding parts 65 and 67 and the third differential operation part 69 have a circuit configuration with two inputs and one output. The two input terminals (+) of the second adding part 65 are connected to the light-receiving regions A and D respectively. The output terminal of the second adding part 65 is connected to a non-inverting input terminal (+) of the third differential operation part 69. The second adding part 65 has a function of adding main beam electrical signals output by the light-receiving regions A and D on one side of the light-receiving element 23 divided by the division line 24. An electrical signal output by the second adding part 65 can be expressed as follows.
A+D Expression 12

The two input terminals (+) of the third adding part 67 are connected to the light-receiving regions B andC respectively. The output terminal of the third adding part 67 is connected to an inverting input terminal (−) of the third differential part 69. The third adding part 67 has a function of adding main beam electrical signals output by the light-receiving regions B and C on the other side of the light-receiving element 23 divided by the division line 24. An electrical signal output by the third adding part 67 can be expressed as follows.
B+C Expression 13

The third differential operation part 69 has a function of performing a differential operation on the electrical signals A+D and B+C output by the second and the third adding parts 65 and 67, respectively. A second preliminary tracking error signal PTES2 output by the third differential operation part 69 can be expressed as follows.
PTES2=(A+D)−(B+C) Expression 14

Expression 14 is similar to an arithmetic expression used in the push-pull method according to the related art. Therefore, the second preliminary tracking error signal detecting portion 63 has a function similar to TES detection based on the push-pull method in the related art.

The TES generating portion 71 has a fourth differential operation part 73 and a signal amplification part 75. An input terminal of the signal amplification part 75 is connected to the output terminal of the first adding part 61, and an output terminal of the same is connected to an inverting input terminal (−) of the fourth differential operation part 73. The signal amplification part 75 has a function of amplifying the first preliminary tracking error signal PTES1 by a factor of k2. An electrical signal output by the signal amplification unit 75 can be expressed as follows.
K2×{(E+H)−(F+G)} Expression 15

Where the coefficient k2 is a coefficient which may be either positive or negative.

An output terminal of the third differential operation part 69 is connected to a non-inverting input terminal (+) of the fourth differential operation part 73. The fourth differential operation part 73 has a function of performing a differential operation on the electrical signal output by the signal amplification part 75 and the second preliminary tracking error signal PTES2 output by the third differential operation part 69. Therefore, a tracking error signal (TES) output by the third differential operation part 69 can be expressed as follows.
TES={(A+D)−(B+C)}−k2×{(E+H)−(F+G)} Expression 16

Expression 16 is similar to an arithmetic expression used in the differential push-pull method in the related art. Therefore, the TES detection circuit of the present embodiment has a function similar to TES detection based on the differential push-pull method in the related art. DC offset components generated in a tracking error signal due to displacement of the objective lens 13 in the radial direction of the medium can be effectively eliminated by setting the coefficient k2 at an optimum value. The differential push-pull method is advantageous from such a point of view. Instead of using the differential push-pull method in the TES detection circuit, the push-pull method may be implemented using only the second preliminary tracking error signal detecting portion 63. Although the push-pull method has the problem of difficulty in eliminating DC offset components, the method is advantageous in that it involves a simply circuit configuration and therefore allows the cost of the optical recording/reproducing apparatus 150 to be reduced.

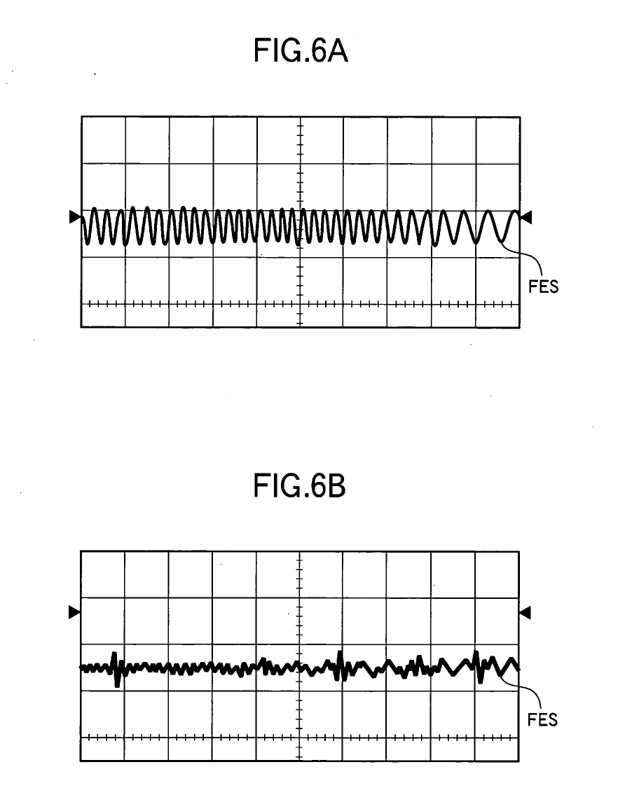

A description will now be made with reference to FIGS. 6 to 10B on optimization of the intervals between the spots of a main beam and sub beams of orders of ±1 in the radial direction of an information recording surface of an optical recording medium 15. FIGS. 6A and 6B show waveforms of focus error signals obtained when a main beam and sub beams of orders of ±1 are focused on an information recording surface of an unrecorded DVD−RAM. FIG. 6A shows a waveform of a focus error signal obtained by astigmatic focus error detection using only the main beam. FIG. 6B shows a waveform of a focus error signal obtained by differential astigmatic focus error detection using the main beam and the sub beams. The abscissa axes of FIGS. 6A and 6B represent time, and the ordinate axes represent amplitude.

A light-receiving portion for obtaining the focus error signals shown in FIGS. 6A and 6B has three light-receiving elements for the main beam and the sub beams of orders of ±1 similar to the light-receiving elements 23, 25a, and 25b shown in FIG. 3. Each of the light-receiving elements has four light-receiving regions which are disposed adjacent to each other in the form of a matrix. The main beam and the sub beams of orders of ±1 form images in the middle of the light-receiving regions of the respective light-receiving elements. The focus error signal based on astigmatic focus error detection is obtained by performing the calculation expressed by Expression 6. The focus error signal based on differential astigmatic focus error detection can be obtained by performing the calculation expressed by Expression 8.

Astigmatic focus error detection has been widely used because it involves a detection circuit having a simple structure. As shown in FIG. 6A, however, the focus error signal based on astigmatic focus error detection has a relatively large signal amplitude. The reason for the large signal amplitude of the focus error signal is the fact that the focus error signal includes a great amount of track cross signals which are generated when a light beam is scanned across steps at the tracks of the optical recording medium through the objective lens. Astigmatic focus error detection has a problem in that it provides a focus error signal including a great amount of track cross signals. The inclusion of track cross signals in a focus error signal is significant in DVD−RAM which are DVD media having a great physical track pitch.

As shown in FIG. 6B, the focus error signal based on differential astigmatic focus error detection has a relatively small signal amplitude, and substantially no track cross signal is included in the focus error signal. According to differential astigmatic focus error detection, an astigmatic signal from a main beam including track cross signal components is added with an astigmatic signal from sub beams including track cross signal components in phase opposition to the above track cross signal components, which allows only the track cross signals included in the two types of beams to be cancelled by each other and thereby eliminated. However, differential astigmatic focus error detection requires that the intervals between the spots of a main beam and sub beams in the radial direction of the medium must be set at about one half the physical track pitch.

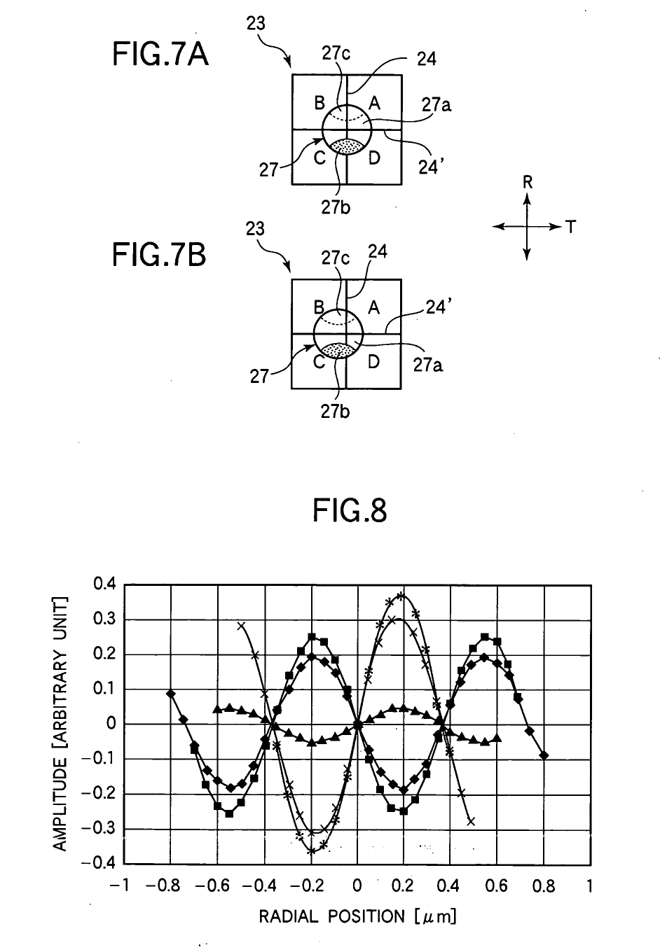

FIGS. 7A and 7B show states of a main beam 27 converged on the light-receiving element 23. FIG. 7A shows a state in which the main beam 27 is converged substantially in the middle of the light-receiving element 23. FIG. 7B shows a state in which the main beam 27 is converged with an offset toward the light-receiving regions B and C of the light-receiving element 23. The horizontal arrow T in the figures represents a direction tangential to a track of a DVD−RAM, and the vertical arrow R represents the radial direction of the DVD−RAM. A plurality of lands and grooves alternately formed on an information recording surface of the DVD−RAM serves as a diffraction grating. Thus, as shown in FIGS. 7A and 7B, the main beam 27 reflected by the DVD−RAM and imaged on the light-receiving surface of the light-receiving element 23 is diffracted, and the main beam 27 therefore includes a zero-order beam 27a, a beam 27b of order of +1, and a beam 27c of order of −1. In FIGS. 7A and 7B, the sub beam 27b of order of +1 which has a relatively high optical intensity is indicated by the solid line, and the beam 27c of order of −1 which has a relatively small intensity is indicated by the broken line.

The position of the main beam 27 converged on the light-receiving element 23 can shift as shown in FIGS. 7A and 7B because of non-uniformity, e.g., aberration, of the intensity of the main beam 27 itself or because of foreign factors such as a positional shift that occurs when the optical path of the main beam 27 is adjusted. Each time the main beam 27 moves across a track of the optical recording medium 15, the intensity distribution of the main beam 27 converged on the light-receiving element 23 may become symmetrical or asymmetrical about the division line 24. Further, each time the main beam 27 moves across a track of the optical recording medium 15, the beams 27b and 27c of orders of ±1 of the main beam 27 may have different intensities. For example, the intensity of the beam 27b of order of +1 may be higher than the intensity of the beam 27c of order of −1. When the main beam 27 converged on the light-receiving element 23 has a positional shift each time the main beam 27 moves across a track of the optical recording medium 15, it is difficult to obtain a uniform focus error signal as shown in FIG. 6A using astigmatic focus error detection in which a focus error signal is obtained by the calculation expressed by Expression 6. As thus described, when a focus error signal is detected using astigmatic focus error detection, the resultant focus error signal is likely to include track cross signals.

FIG. 8 shows a result of a simulation in which states of track cross signals included in the main beam and sub beams are calculated using the scalar diffraction theory. The abscissa axis represents positions in the radial direction (μm) of the optical recording medium, and the ordinate axis represents the amplitude (in arbitrary unit) of the track cross signals. The curve connecting the solid diamond-like symbols in the figure indicates a track cross signal included in the main beam. The curve connecting the solid square symbols in the figure represents a track cross signal included in the sub beams when the intervals between the spots of the main beam and the sub beams of orders of ±1 in the radial direction of the medium are 0.135 times the physical track pitch. The curve connecting the solid triangular symbols in the figure.represents a track cross signal included in the sub beams when the intervals between the spots of the main beam and the sub beams of orders of ±1 in the radial direction of the medium are 0.270 times the physical track pitch. The curve connecting the crosses in the figure represents a track cross signal included in the sub beams when the intervals between the spots of the main beam and the sub beams of orders of ±1 in the radial direction of the medium are 0.405 times the physical track pitch. The curve connecting the asterisks in the figure represents a track cross signal included in the sub beams when the intervals between the spots of the main beam and the sub beams of orders of ±1 in the radial direction of the medium are 0.541 times the physical track pitch. A track cross signal included in the sub beams is calculated by adding track cross signals included in the sub beams of orders of ±1.

Since track cross signals included in the sub beams of orders of ±1 are added, the track cross signal included in the main beam and the track cross signals included in the sub beams are always at a phase difference of 0 or 180 deg (i.e., are in phase or in phase opposition) regardless of the intervals between the main beam and the sub beams. In a critical position where the phase difference between the track cross signals included in the main beam and the sub beams changes from the in-phase state to the state of phase opposition, substantially no track cross signal enters the sub beams.

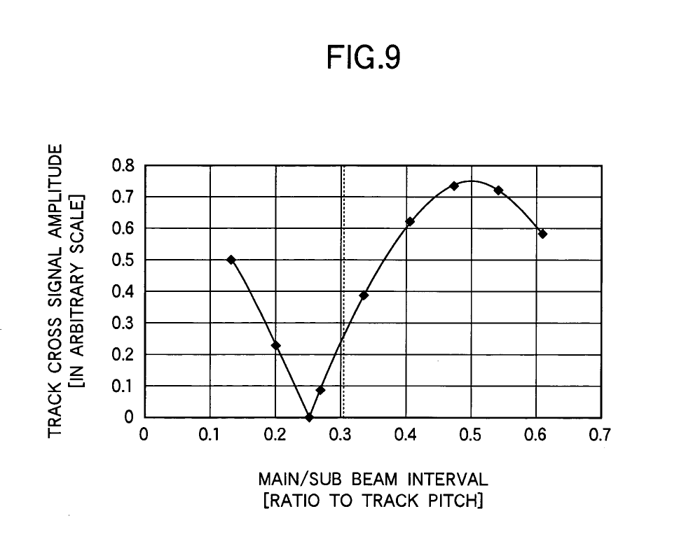

FIG. 9 shows changes in the amplitude of a track cross signal included in a sub beam with respect to the interval between the spots of the main beam and the sub beam in the radial direction of the optical recording medium. The abscissa axis represents the interval between the spots of the main beam and the sub beam in terms of the ratio of the same to the physical track pitch of the optical recording medium, and the ordinate axis represents the amplitude (in arbitrary unit) of the track cross signal. The vertical broken line in FIG. 9 represents the ratio of a spot interval BP to the physical track pitch of a DVD−RAM when the spot interval BP between the main beam and sub beams of order of ±1 is 0.37 μm.

As shown in FIG. 9, the amplitude of the track cross signal included in the sub beam reaches the maximum when the spot interval between the main beam and the sub beam is ½ times the physical track pitch and becomes 0 when the intervals becomes ¼ times. The optical head 1 of the present embodiment utilizes such a characteristic of a track cross signal included in a sub beam.

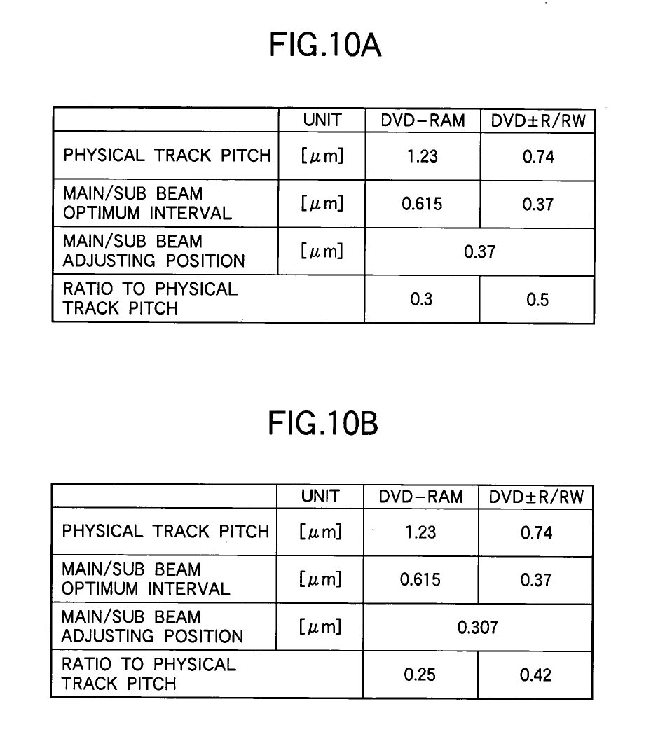

FIGS. 10A and 10B show the physical track pitches of DVD−RAM and DVD±R/RW and optimum values of the interval between spots of a main beam and a sub beam when differential astigmatic focus error detection is used. FIG. 10A shows an example in which the interval between the spots of the main beam and the sub beam is adjusted to an optimum value of the interval on a DVD±R/RW. FIG. 10B shows an example in which the interval between the spots of the main beam and the sub beam in the optical head 1 in the embodiment of the invention is adjusted. As shown in FIG. 10A, when the interval of the spots of the main beam and the sub beam is 0.37 μm, since the spot interval is 0.5 (½) times the physical track pitch of a DVD±R/RW, a focus error signal can be detected with track cross signals eliminated using differential astigmatic focus error detection. In the case of a DVD−RAM, since the spot interval is 0.3 times the physical track pitch as indicated by the broken line in FIG. 9, track cross signals can not be satisfactorily eliminated from a focus error signal even when differential astigmatic focus error detection is used.

The optical head 1 of the present embodiment is adjusted such that the spot interval BP between a main beam and a sub beam becomes substantially ¼ times the relatively large physical track pitch P1 of a DVD−RAM. Specifically, the spot interval is adjusted to 0.307 μm as shown in FIG. 10B. The ratio of the spot interval BP to the physical track pitch P1 of a DVD−RAM is 0.307 μm/1.23 μm=0.25. Therefore, as shown in FIG. 9, track cross signal components included in sub beams can be suppressed to substantially zero by generating an astigmatic signal through a calculation of sub beams of orders of ±1 in the case of a DVD−RAM.

The ratio of the spot interval BP to the physical track pitch of a DVD±R/RW is 0.307 μm/0.74 μm=0.42 which is substantially equivalent to ½. In this case, as shown in FIG. 9, the amplitude of track cross signals included in sub beams of orders of ±1 is about 0.65 which is substantially 87% of a maximum amplitude of 0.75. As thus described, the sub beams of orders of ±1 include a relatively great amount of track cross signals. Therefore, the spot interval is suitable for the generation of a differential astigmatic signal where track cross signals have a great amplitude. The spot interval BP between a main beam and sub beams may be set at substantially ¼ times the physical track pitch P1 of a DVD−RAM and at substantially ½ times the physical track pitch P2 of a DVD±R/RW. Differential astigmatic focus error detection may be performed using sub beams of orders of ±1 to detect a focus error signal from a DVD−RAM, and differential astigmatic focus error detection may be performed using a main beam and sub beams of orders of ±1 to detect a focus error signal from a DVD±R/RW. Thus, a focus error signal can be detected with track cross signals attenuated from either of the two types of optical recording media having different physical track pitches.

Referring to FIGS. 2A, 2B, and 2C, the optical head 1 is adjusted such that the spot intervals BP between the main beam 27 and the sub beams 29a and 29b of orders of ±1 in the radial direction of the information recording surface of the optical recording medium 15 become substantially ¼ times the physical track pitch P1 of the first optical recording medium 15a and such that the spot intervals BP become substantially ½ times the physical track pitch P2 of the second optical recording medium 15b. Further, the error signal detection unit 31 can be switched to use differential astigmatic focus error detection utilizing the sub beams 29a and 29b of orders of ±1 or differential astigmatic focus error detection utilizing the main beam 27 and the sub beams 29a and 29b of orders of ±1 depending on the length of physical track pitch of the optical recording medium 15. Therefore, the optical recording/reproducing apparatus 150 having the optical head 1 and the error signal detection unit 31 can detect a focus error signal with track cross signals attenuated from either of the two types of optical recording media 15 having different physical track pitches.

Operations of the optical head 1 and the error signal detection unit 31 will now be described with reference to FIGS. 1 and 3. As shown in FIG. 1, a divergent light beam emitted by a laser diode 3 enters the diffraction grating 19. The light beam is split by the diffraction grating 19 into a zero-order main beam 27 and sub beams 29a and 29b of orders of ±1. The divergent main beam 27 and sub beams 29a and 29b of orders of ±1 which have exited the diffraction grating 19 enter the polarization beam splitter 5. Linearly polarized components at a predetermined polarization direction of the main beam 27 and the sub beams 29a and 29b of orders of ±1 transmit by the polarization beam splitter 5 and enter the quarter-wave plate 7. On the contrary, linearly polarized components orthogonal to the polarization direction reflect and enter the power monitoring photodiode 11 which measures the intensity of the light beam.

The linearly polarized main beam 27 and sub beams 29a and 29b of orders of ±1 which have entered the quarter-wave plate 7 are transmitted by the quarter-wave plate 7 to be converted into circularly polarized main beam 27 and sub beams 29a and 29b of orders of ±1. The circularly polarized main beam 27 and sub beams 29a and 29b of orders of ±1 are converted by the collimator lens 9 into parallel breams which are converged by the objective lens 13 after passing through the collimator lens 9 and are converged and reflected on the information recording surface of the optical recording medium 15. At this time, the spot intervals between the main beam 27 and the sub beams 29a and 29b of orders of ±1 in the radial direction of the medium are about 0.307 μm, and the spot interval between the sub beams 29a and 29b of orders of ±1 in the radial direction is 0.614 μm. The circularly polarized main beam 27 and sub beams 29a and 29b of orders of ±1 reflected on the information recording surface of the optical recording medium 15 are converted by the objective lens 13 into parallel beams which are then transmitted by the collimator lens 9 to enter the quarter-wave plate 7. When transmitted by the quarter-wave plate 7, the circularly polarized main beam 27 and sub beams 29a and 29b of orders of ±1 are converted into linearly polarized beams whose polarizing direction is at a rotation of 90° from that of the initial linearly polarized beams, and the linearly polarized beams enter the polarization beam splitter 5. The linearly polarized main beam 27 and sub beams 29a and 29b of orders of ±1 are reflected by the polarization beam splitter 5 and enter the sensor lens 17.

The cylindrical lens 21 imparts astigmatism to the main beam 27 and sub beams 29a and 29b of orders of ±1 after the beams are transmitted by the sensor lens 17, and the beams are then collected on the light-receiving elements 23, 25a, and 25b, respectively. The main beam 27 and sub beams 29a and 29b of orders of ±1 received by the light-receiving elements 23, 25a, and 25b, respectively, are converted into a main beam electrical signal and first and second sub beam electrical signals which are input to the error signal detection unit 31. The error signal detection unit 31 detects a focus error signal in which track cross signals have been attenuated by using the main beam electrical signal and the first and the second sub beam electrical signals regardless of the type of the medium, i.e., the first or the second optical recording medium 15a or 15b. Further, the error signal detection unit 31 detects a tracking error signal from the main beam electrical signal and the first and the second sub beam electrical signals.

A method of detecting a focus error signal used in the optical head of the present embodiment will be described. As seen in the above description of the operation of the optical head 1, a light beam emitted by the laser diode 3 enters the diffraction grating 19 which diffracts the light beam and split it into a main beam 27 and sub beams 29a and 29b of orders of ±1. Next, as shown in FIGS. 1 to 2C, the main beam 27 and sub beams 29a and 29b of orders of ±1 which have been collected on the optical recording medium 15 through the objective lens 13 are adjusted such that they are at spot intervals BP of 0.307 μm in the radial direction of the medium. The spot intervals BP are adjusted by rotating the grating surface of the diffraction grating 19 about the optical axis of the diffraction grating 19.

Then, the main beam 27 and sub beams 29a and 29b of orders of ±1 reflected by the optical recording medium 15 are collected on the acceptance surface of light-receiving elements 23, 25a, and 25b, respectively. By receiving the main beam 27 and sub beams 29a and 29b of orders of ±1 on the light-receiving elements 23, 25a, and 25b, a main beam electrical signal is output from the light-receiving element 23 to the error signal detection unit 31, and the first and the second sub beam electrical signals are output from the light-receiving elements 25a and 25b to the error signal detection unit 31.

A focus leading operation is performed to lead the objective lens 13 into a range in which a focal position can be controlled. During the focus leading operation, the switch 50 is switched such that the output terminal of the second preliminary focus error detecting portion 41 is connected to the output terminal of the switch 50 regardless of the medium type, i.e., the first or the second optical recording medium 15a or 15b. Therefore, the error signal detection unit 31 detects the second preliminary focus error signal PFES2 as a focus error signal during the focus leading operation. Thus, the operation of leading the focus of the objective lens 13 can be performed using a focus error signal having no zero cross signal superimposed thereon.

When the focus leading operation is completed, for example, a focal position control (a focal position adjustment) is performed as a focus follow-up control of the objective lens 13. At the error signal detection unit 31, the arithmetic processes expressed by Expressions 1 to 8 are performed by the first preliminary focus error signal detecting portion 33, the second preliminary focus error signal detecting portion 41, and the third preliminary focus error signal detecting portion 49 using the main beam electrical signal and the first and the second sub beam electrical signals. When the first optical recording medium 15a is disposed as the optical recording medium 15, the switch 50 is switched such that the output terminal of the first preliminary focus error signal detecting portion 33 is connected to the output terminal of the switch 50. In the case of the first optical recording medium 15a, the first preliminary focus error signal PFES1 in which track cross signals have been attenuated is output from the first preliminary focus error signal detecting portion 33. Therefore, a focus error signal can be detected by the error signal detection unit 31 with track cross signals attenuated.

When the second optical recording medium 15b is disposed as the optical recording medium 15, the switch 50 is switched such that the output terminal of the third preliminary focus error signal detecting portion 49 is connected to the output terminal of the switch 50. In the case of the second optical recording medium 15b, the third preliminary focus error signal PFES3 in which track cross signals have been attenuated is output from the third preliminary focus error signal detecting portion 49. Therefore, a focus error signal can be detected by the error signal detection unit 31 with track cross signals attenuated.

As described above, the optical head 1 of the present embodiment is adjusted such that the spot intervals BP between the main beam 27 and the sub beams 29a and 29b of orders of ±1 converged on the information recording surface of the optical recording medium 15 in the radial direction of the medium become substantially ¼ times the physical track pitch P1 of the first optical recording medium 15a and substantially ½ times the physical track pitch P2 of the second optical recording medium 15b. The error signal detection unit 31 can be switched such that it detects a focus error signal obtained only from the sub beams 29a and 29b of orders of ±1 in the case of the first optical recording medium 15a and such that it detects a focus error signal obtained according to a differential astigmatic focus error detection method similar to those in the related art using the main beam 27 and the sub beams 29a and 29b of orders of ±1 in the case of the second optical recording medium 15b. As a result, the optical recording/reproducing apparatus 150 having the optical head 1 and the error signal detection unit 31 is capable of detecting a focus error signal in which track cross signals have been attenuated regardless of the length of physical track pitch of the optical recording medium 15.

Further, the error detection signal detection unit 31 can detect the second preliminary focus error signal PFES2 as a focus error signal from either of the first and the second optical recording media 15a and 15b during the operation of leading the focus of the objective lens 13. Therefore, the optical head 1 can perfom the operation of leading the focus of the objective lens 13 using a focus error signal having no second zero cross signal superimposed thereon. As a result, the focuses of the main beam 27 and the sub beams 29a and 29b of orders of ±1 can be properly led to the information recording surface of the first or the second optical recording medium 15a or 15b.

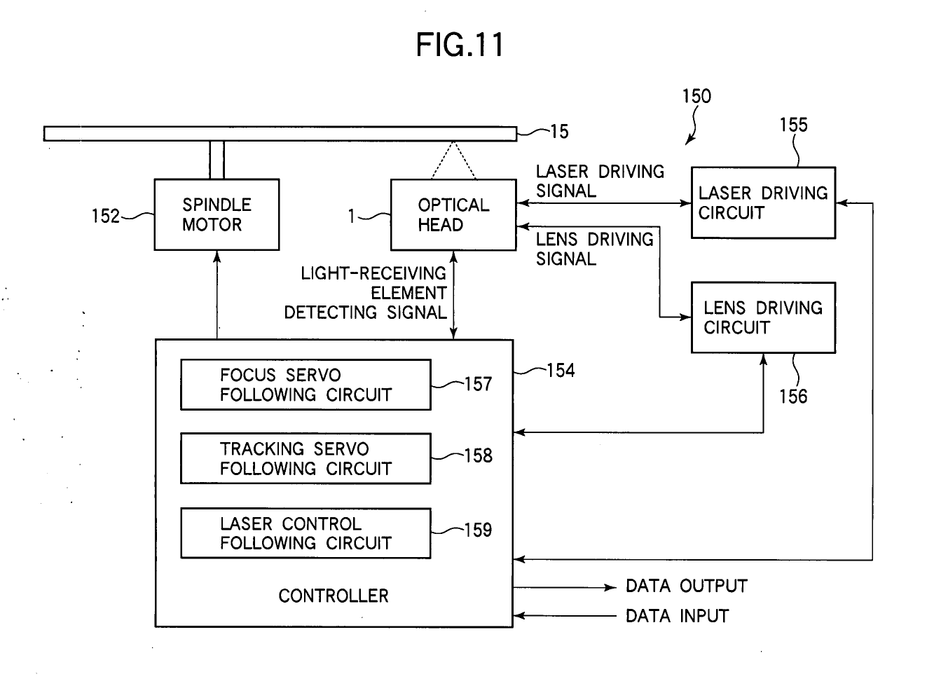

The optical recording/reproducing apparatus of the present embodiment will now be described. FIG. 11 shows a schematic configuration of the optical recording/reproducing apparatus 150 loaded with the optical head 1 of the present embodiment. As shown in FIG. 11, the optical recording/reproducing apparatus 150 includes a spindle motor 152 for rotating an optical recording medium 15, an optical head 1 for irradiating the optical recording medium 15 with a laser beam and for receiving light reflected by the same, a controller 154 for controlling the operation of the spindle motor 152 and the optical head 1, a laser driving circuit 155 for supplying a laser driving signal to the optical head 1, and a lens driving circuit 156 for supplying a lens driving signal to the optical head 1.

The controller 154 includes a focus servo following circuit 157, a tracking servo following circuit 158, and a laser control circuit 159. The error signal detection unit 31 is provided across the focus servo following circuit 157 and the tracking servo following circuit 158. When the focus servo following circuit 157 operates, the information recording surface of the rotating optical recording medium 15 is focused. When the tracking servo following circuit 158 operates, a laser beam spot automatically follows up any eccentric signal track of the optical recording medium 15. The focus servo following circuit 157 and the tracking servo following circuit 158 are provided with an automatic gain control function for automatically adjusting a focus gain and a tracking gain, respectively. The laser control circuit 159 is a circuit for generating a laser driving signal to be supplied by the laser driving circuit 155, and the circuit generates an adequate laser driving signal based on recording condition setting information that is recorded in the optical recording medium 15.

It is not essential that the focus servo following circuit 157, the tracking servo following circuit 158, and the laser control circuit 159 are circuits incorporated in the controller 154, and the circuits may be components separate from the controller 154. Further, it is not essential that those elements are physical circuit, and they maybe programs executed in the controller 154.

### SECOND EMBODIMENT

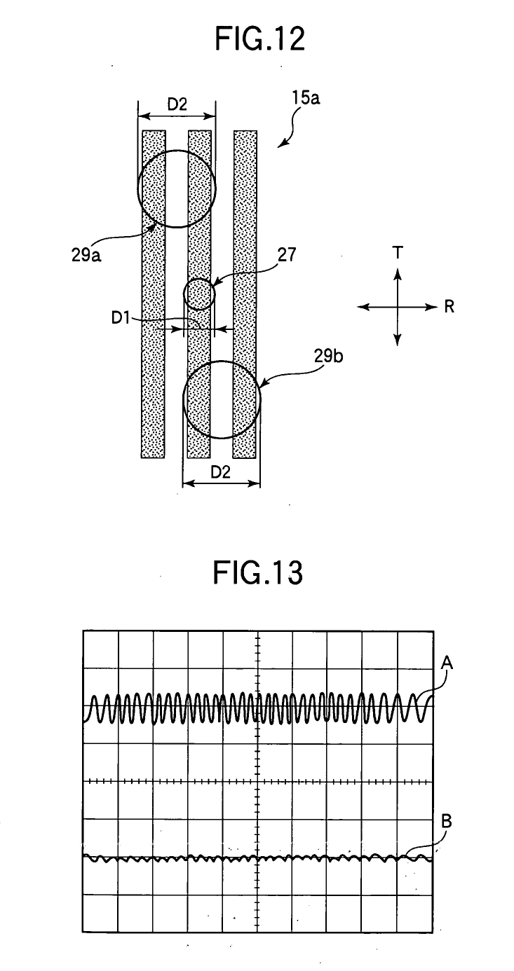

A description will now be made with reference to FIGS. 12 to 14 on a method of detecting a focus error signal of an optical head and an optical recording/reproducing apparatus utilizing the same according to a second embodiment of the invention. An optical head of the present embodiment has a feature in that it employs a special diffraction grating having a wavy grating pattern as a diffracting element for forming sub beams on an information recording surface of an optical recording medium. The configuration of an optical head 1 of the present embodiment will not be described because it is the same as that of the optical head 1 of the first embodiment except that the special diffraction grating is used instead of the diffraction grating 19. The configuration of the optical recording/reproducing apparatus of the present embodiment will not be described because it is the same as that of the optical recording/reproducing apparatus 150 of the first embodiment.

For example, the special diffraction grating has a grating pattern having a grating pitch which changes on a predetermined cycle. When the grating pitch changes on a predetermined cycle, aberration can be imparted to light beams that exit the special diffraction grating other than a main beam. FIG. 12 schematically shows a main beam 27 and sub beams 29a and 29b of orders of ±1 converged on an information recording surface of a first optical recording medium 15a. The arrow R in the horizontal direction of the figure represents the radial direction of the first optical recording medium 15a, and the arrow T in the vertical direction represents a direction tangential to a track of the first optical recording medium 15a.

As shown in FIG. 12, the use of the special diffraction grating makes it possible to make the radial spot diameter D2 of the sub beams 29a and 29b of orders of ±1 converged on the information recording surface of the first optical recording medium 15a in the radial direction of the medium greater than a radial spot diameter D1 of the main beam 27 in the radial direction of the medium. The grating pattern of the special diffraction grating is formed to achieve a relationship expressed by D2/D1≧2.5. It is not essential that the sub beams 29a and 29b of orders of ±1 have a circular spot shape, and they may be elliptic and the like as long as the radial spot diameter D2 is 2.5 times or more the spot diameter D1 of the main beam in the same direction.

When the sub beams 29a and 29b of orders of ±1 have the great radial spot diameter D2, a cut-off frequency of an optical transfer coefficient of the sub beams 29a and 29b of orders of ±1 is shifted to the lower side, and track cross signal components having a high spatial frequency (the inverse of the track pitch) are therefore eliminated. Therefore, the sub beams 29a and 29b of orders of ±1 reflected by the first optical recording medium 15a are received by light-receiving elements 25a and 25b, and an arithmetic process similar to that in the optical head 1 of the first embodiment is performed on first and second sub beam electrical signals output by the light-receiving elements 25a and 25b using the first preliminary focus error signal detecting portion 33 shown in FIG. 4. As a result, a focus error signal can be detected while suppressing entry of track cross signals to a smaller amount.

FIG. 13 shows results of measurement on focus error signals obtained using the optical head having the special diffraction grating according to astigmatic focus error detection based on reflected light from a DVD−RAM (first optical recording medium 15a). The abscissa axis represents time, and the ordinate axis represents amplitude. The curve indicated by A in the figure represents a waveform of a focus error signal obtained using only the main beam 27, and the curve indicated by B in the figure represents a waveform of a focus error signal obtained using only the sub beams 29a and 29b of orders of +1.

As shown in FIG. 13, the waveform B of the focus error signal based on the sub beams 29a and 29b of orders of ±1 have an amplitude smaller than that of the waveform A of the focus error signal based on the main beam 27, which indicates that the amount of track cross signals included in the focus error signal based on the sub beams 29a and 29b of orders of ±1 is significantly smaller.

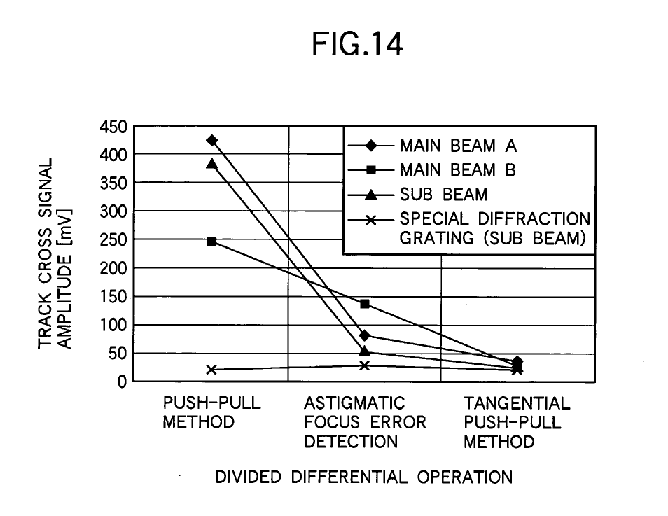

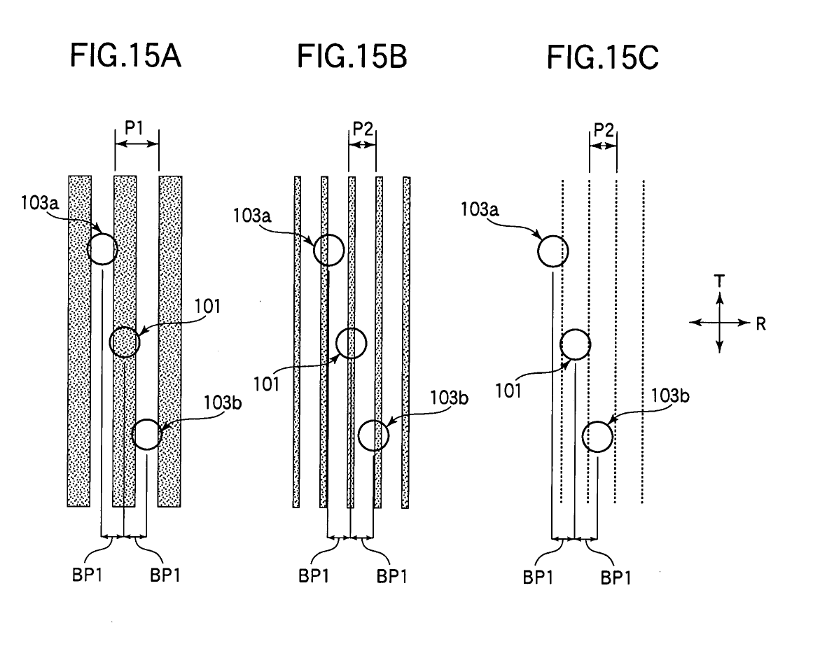

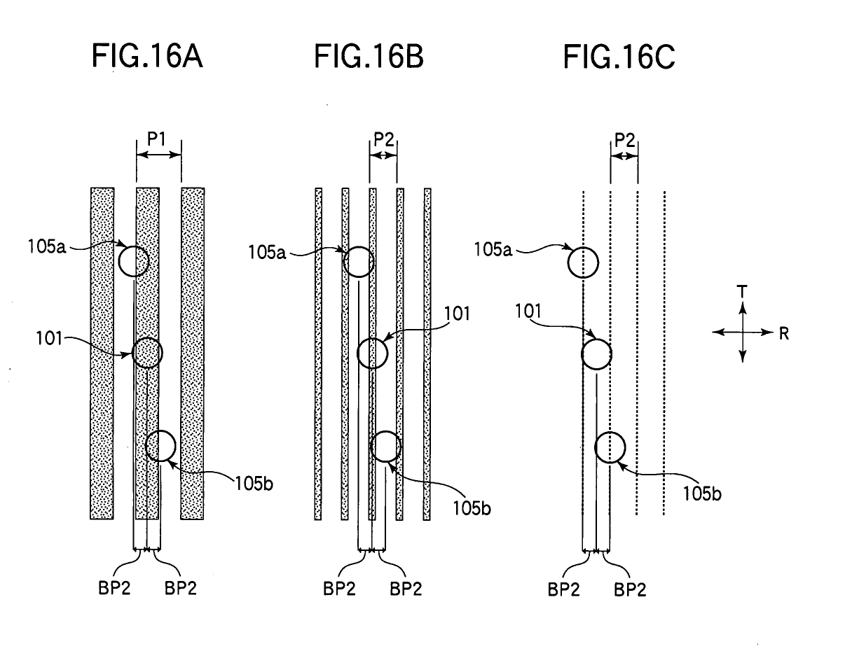

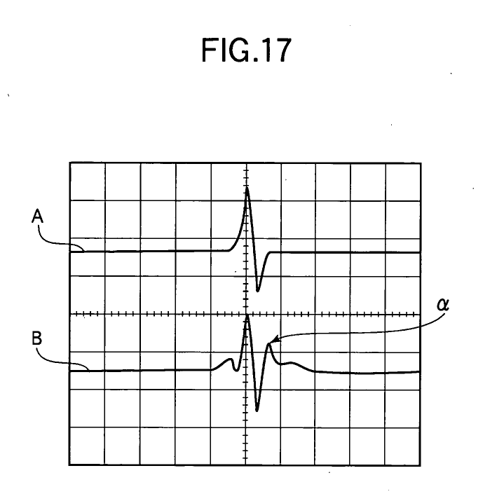

FIG. 14 shows amplitudes of track cross signal components obtained by various types of differential operations using light received by a light-receiving element whose light-receiving area is divided into four regions by two division lines crossing each other. The abscissa axis represents the types of methods of differential operation, and the ordinate axis represents the amplitude of the track cross signals (mV). The solid diamond-like symbols in the figure indicate the amplitude of a track cross signal calculated at an optical head A using a main beam A. The solid square symbols in the figure indicate the amplitude of a track cross signal calculated at an optical head B different from the optical head A using a main beam B. The solid triangular symbols in the figure indicate the amplitude of a track cross signal calculated at the optical head A using sub beams. The crosses in the figure indicate the amplitude of a track cross signal calculated using sub beams at the optical head having the special diffraction grating of the present embodiment. The tangential push-pull method is a method in which the division line of the light-receiving regions that is orthogonal to a direction tangential to a track is used as the axis of symmetry for a differential operation. Referring to FIG. 3, for example, the amplitude of a track cross signal is obtained from (A+B)−(C+D) using the division line 24′ as the axis of symmetry in the tangential push-pull method.

As shown in FIG. 14, the amplitudes of the track cross signals based on the main beams A and B and the sub beams indicated by the solid diamond, square, and triangular symbols significantly vary depending on the methods of calculation because of the influence of factors including asymmetry of the light beam spots converged on the light-receiving regions. On the contrary, when the special diffraction grating is used, since track cross signal components included in sub beams are eliminated, the amplitude of the track cross signal is substantially constant regardless of the method of calculation. Further, the sub beams obtained using the special diffraction grating has a track cross signal amplitude smaller than those obtained from the main beams A and B and the sub beams indicated by the solid diamond, square, and triangular symbols in the figure.

As described above, the optical head 1 of the present embodiment can be eliminated track cross signal components included in the sub beams 29a and 29b of orders of ±1 by making the radial spot diameter D2 of the sub beams 29a and 29b of orders of ±1 in the radial direction of the first optical recording medium 15a 2.5 times or more the spot diameter D1 of the main beam 27 in the same direction. A focus error signal in which track cross signals are significantly attenuated can be detected by performing a differential arithmetic process on first and second sub beam electrical signals based on the sub beams 29a and 29b of orders of ±1.

Since the optical head of the present embodiment eliminates track cross signal components included in the sub beams 29a and 29b of orders of ±1, a focus error signal in which track cross signals are significantly attenuated can be detected based on the sub beams 29a and 29b of orders of ±1 not only from the first optical recording medium 15a but also from the second optical recording medium 15b such as a DVD±R/RW or DVD−ROM.

The invention is not limited to the above-described embodiments and may be modified in various ways.

Although the optical head 1 of the first and the second embodiments has the light-receiving elements 23, 25a, and 25b having four light-receiving regions disposed adjacent to each other in the form of amatrix, this is not limiting the invention. For example, the light-receiving area of the light-receiving elements 23, 25a, and 25b may be divided into five or more regions. Advantages similar to those described above can be also achieved in such a case.

What is claimed is:

1. A method of detecting a focus error signal of an optical head, comprising the steps of:
diffracting a light beam emitted by a light source to split the beam into a main beam and two sub beams and converging the beams on an optical recording medium through an objective lens;
converting the main beam and the two sub beams reflected by the optical recording medium into electrical signals; and
detecting the focus error signal to be used for adjusting the focal position of the objective lens through an arithmetic process performed by switching a combination of the electrical signal based on the main beam and the electrical signals based on the two sub beams at the time of a focus leading operation for leading the objective lens into a range in which the focal position can be controlled or at the time of a focus follow-up control of the objective lens performed after the focus leading operation.

2. A method of detecting a focus error signal of an optical head according to claim 1, wherein the focus error signal is detected by performing an arithmetic process on the electrical signal based on the main beam at the time of the focus leading operation and is detected by performing an arithmetic process on the electrical signals based on the two sub beams at the time of the focus follow-up control.

3. A method of detecting a focus error signal of an optical head according to claim 1, wherein:
when the focus follow-up control is performed on a first optical recording medium having a physical track pitch P1, the focus error signal in which a track cross signal generated when the objective lens moves across a track of the first optical recording medium has been attenuated is detected by performing the arithmetic process on the electrical signals based on the two sub beams reflected by the first optical recording medium; and
when the focus follow-up control is performed on a second optical recording medium having a physical track pitch P2 (P2<P1), the focus error signal is detected by performing the arithmetic process on the electrical signal based on the main beam reflected by the second optical recording medium.

4. A method of detecting a focus error signal of an optical head according to claim 3, wherein the focus error signal is detected while adjusting the positions of the spots of the two sub beams without changing the intervals between the main beam and the two sub beams converged on a surface of the first or the second optical recording medium such that one of the two sub beams is positioned at an offset of about +P1×(n+¼) in the radial direction from the position of the spot of the main beam and the other sub beam is positioned at an offset of about −P1×(n+¼) from the same on the first optical recording medium and such that one of the two sub beams is positioned at an offset of about +P2×(n+½) in the radial direction from the position of the spot of the main beam and the other sub beam is positioned at an offset of about −P2×(n+½) from the same on the second optical recording medium where n represents 0 or a greater integer.

5. A method of detecting a focus error signal of an optical head according to claim 3, comprising the steps of:
receiving one of the two sub beams reflected by the first or the second optical recording medium with a first light-receiving element for sub beams and receiving the other with a second light-receiving element for sub beams;
detecting a first preliminary focus error signal by adding a first sub beam electrical signal output by the first light-receiving element for a sub beam and a second sub beam electrical signal output by the second light-receiving element for a sub beam;
receiving the main beam reflected by the first or the second optical recording medium with a light-receiving element for a main beam;
detecting a second preliminary focus error signal based on a main beam electrical signal output by the light-receiving element for a main beam;
selecting the first preliminary focus error signal as the focus error signal in the case of the first optical recording medium; and
selecting the second preliminary focus error signal as the focus error signal in the case of the second optical recording medium.

6. A method of detecting a focus error signal of an optical head according to claim 5, wherein in the case of the first optical recording medium:
a first sub beam addition signal is generated by adding the first sub beam electrical signal output by one of diagonal pairs of light-receiving regions of the first light-receiving element for a sub beam which has four light-receiving regions disposed adjacent to each other in the form of a matrix and the second sub beam electrical signal output by one of diagonal pairs of light-receiving regions of the second light-receiving element for a sub beam which has four light-receiving regions disposed adjacent to each other in the form of a matrix;
a second sub beam addition signal is generated by adding the first sub beam electrical signal output by the other pair of light-receiving regions of the first light-receiving element for a sub beam and the second sub beam electrical signal output by the other pair of light-receiving regions of the second light-receiving element for a sub beam; and
a differential operation is performed on the first and the second sub beam addition signals to generate the first preliminary focus error signal which is then detected as the focus error signal.

7. A method of detecting a focus error signal of an optical head according to claim 5, wherein in the case of the second optical recording medium:
a first main beam addition signal is generated by adding the main beam electrical signals output by one of diagonal pairs of light-receiving regions of the light-receiving element for a main beam which has four light-receiving regions disposed adjacent to each other in the form of a matrix;
a second main beam addition signal is generated by adding the main beam electrical signals output by the other pair of light-receiving regions of the light-receiving element for a main beam; and
a differential operation is performed on the first and the second main beam addition signals to generate the second preliminary focus error signal which is then detected as the focus error signal.

8. A method of detecting a focus error signal of an optical head according to claim 3, comprising the steps of:
receiving one of the two sub beams reflected by the first or the second optical recording medium with a first light-receiving element for sub beams and receiving the other with a second light-receiving element for sub beams;
detecting a first preliminary focus error signal by adding a first sub beam electrical signal output by the first light-receiving element for a sub beam and a second sub beam electrical signal output by the second light-receiving element for a sub beam;
receiving the main beam reflected by the first or the second optical recording medium with a light-receiving element for a main beam; detecting the second preliminary focus error signal based on the main beam electrical signal output from the light-receiving element for the main beam;
generating a third preliminary focus error signal by adding the first preliminary focus error signal and the second preliminary focus error signal; and
detecting the second or the third preliminary focus error signal as the focus error signal in the case of the second optical recording medium.

9. A method of detecting a focus error signal of an optical head according to claim 8, wherein in the case of the first optical recording medium:
a first sub beam addition signal is generated by adding the first sub beam electrical signal output by one of diagonal pairs of light-receiving regions of the first light-receiving element for a sub beam which has four light-receiving regions disposed adjacent to each other in the form of a matrix and the second sub beam electrical signal output by one of diagonal pairs of light-receiving regions of the second light-receiving element for a sub beam which has four light-receiving regions disposed adjacent to each other in the form of a matrix;
a second sub beam addition signal is generated by adding the first sub beam electrical signal output by the other pair of light-receivingregionsof thefirstlight-receivingelement for a sub beam and the second sub beam electrical signal output by the other pair of light-receiving regions of the second light-receiving element for a sub beam; and
a differential operation is performed on the first and the second sub beam addition signals to generate the first preliminary focus error signal which is then detected as the focus error signal.

10. A method of detecting a focus error signal of an optical head according to claim 8, wherein in the case of the second optical recording medium:
a first main beam addition signal is generated by adding the first main beam electrical signals output by one of diagonal pairs of light-receiving regions of the light-receiving element for a main beam which has four light-receiving regions disposed adjacent to each other in the form of a matrix;
a second main beam addition signal is generated by adding the main beam electrical signals output by the other pair of light-receiving regions of the light-receiving element for a main beam;
a differential operation is performed on the first and the second main beam addition signals to generate the second preliminary focus error signal; and
the second or the third preliminary focus error signal is detected as the focus error signal.

11. A method of detecting a focus error signal of an optical head according to claim 1, wherein the diameter of the spots of the two sub beams imaged on a surface of the optical recording medium in the radial direction of the optical recording medium is 2.5 times or more the diameter of the spot of the main beam in the same direction and wherein the focus error signal in which the track cross signal has been attenuated is detected by performing the arithmetic process on the electrical signals based on the two sub beams reflected on the surface of the optical recording medium.

12. An optical recording/reproducing apparatus comprising:
an optical head including a diffraction grating for diffracting a light beam emitted by a light source to emit a main beam and two sub beams, an objective lens for converging the main beam and the two sub beams on an optical recording medium, and a light-receiving element for receiving each of the main beam and the two sub beams reflected by the optical recording medium and for converting each beam into an electrical signal; and
an error signal detection unit for generating a focus error signal to be used for adjusting the focal position of the objective lens through an arithmetic process performed by switching the combination of the electrical signal based on the main beam and the electrical signals based on the two sub beams at the time of a focus leading operation for leading the objective lens into a range in which the focal position can be controlled or a focus follow-up control of the objective lens performed after the focus leading operation.

13. An optical recording/reproducing apparatus according to claim 12, wherein the error signal detection unit detects the focus error signal obtained by performing the arithmetic process on the electrical signal based on the main beam at the time of the focus leading operation and detects the focus error signal obtained by performing the arithmetic process on the electrical signals based on the two sub beams at the time of the focus follow-up control.

14. An optical recording/reproducing apparatus according to claim 12, wherein:
when the focus follow-up control is performed on a first optical recording medium having a physical track pitch P1, the error signal detection unit detects the focus error signal in which a track cross signal generated when the objective lens moves across a track of the first optical recording medium has been attenuated, by performing the arithmetic process on the electrical signals based on the two sub beams reflected by the first optical recording medium; and
when the focus follow-up control is performed on a second optical recording medium having a physical track pitch P2 (P2<P1), the error signal detection unit detects the focus error signal by performing the arithmetic process on the electrical signal based on the main beam reflected by the second optical recording medium.

15. An optical recording/reproducing apparatus according to claim 14, wherein the error signal detection unit includes a switch which is controlled such that the focus error signal obtained by performing the arithmetic process on the electrical signals based on the two sub beams is selected in the case of the first optical recording medium and such that the focus error signal obtained by performing the arithmetic process on the electrical signal based on the main beam is selected in the case of the second optical recording medium.

16. An optical recording/reproducing apparatus according to claim 15, wherein:
when the focus leading operation is performed, the switch is controlled so as to select the focus error signal obtained by performing the arithmetic process on the electrical signal based on the main beam reflected by the first or the second optical recording medium; and
when the focus follow-up control is performed, the switch is controlled so as to select the focus error signal obtained by performing the arithmetic process on the electrical signals based on the two sub beams reflected by the first optical recording medium in the case of the first optical recording medium and to select the focus error signal obtained by performing the arithmetic process on the electrical signal based on the main beam reflected by the second optical recording medium in the case of the second optical recording medium.

17. An optical recording/reproduction apparatus according to claim 14, wherein the light-receiving element comprises a light-receiving element for a main beam which has four light-receiving regions disposed adjacent to each other in the form of a matrix and which receives the main beam reflected by the first or the second optical recording medium, a first light-receiving element for a sub beam which has four light-receiving regions disposed adjacent to each other in the form of a matrix and which receives one of the two sub beams reflected by the first or the second optical recording medium, and.a second light-receiving element for a sub beam which has four light-receiving regions disposed adjacent to each other in the form of matrix and which receives the other of the two sub beams reflected by the first or the second optical recording medium.

18. An optical recording/reproducing apparatus according to claim 17, wherein the error signal detection unit detects the focus error signal in which the track cross signal has been attenuated based on a first sub beam electrical signal output by the first light-receiving element for a sub beam and a second sub beam electrical signal output by the second light-receiving element for a sub beam in the case of the first optical recording medium and detects the focus error signal based on a main beam electrical signal output by the light-receiving element for a main beam in the case of the second optical recording medium.

19. An optical recording/reproducing apparatus according to claim 14, wherein the focus error signal in which the track cross signal has been attenuated is detected while adjusting the positions of the spots of the two sub beams without changing the spot intervals between the main beam and the two sub beams converged on a surface of the first or the second optical recording medium such that one of the two sub beams is positioned at an offset of about +P1×(n+¼) in the radial direction from the position of the spot of the main beam and the other sub beam is positioned at an offset of about −P1×(n+¼) from the same on the first optical recording medium and such that one of the two sub beams is positioned at an offset of about +P2×(n +½) in the radial direction from the position of the spot of the main beam and the other sub beam is positioned at an offset of about −P2×(n+½) from the same on the second optical recording medium where n represents 0 or a greater integer.

20. An optical recording/reproducing apparatus according to claim 18, wherein the error signal detection unit includes a first preliminary focus error signal detecting portion which detects a first preliminary focus error signal that is the electrical signals based on the two sub beams reflected by the first or the second optical recording medium, having:
a first adding part for adding the first sub beam electrical signal output by one of the diagonal pairs of light-receiving regions of the first light-receiving element for a sub beam and the second sub beam electrical signal output by one of the diagonal pairs of light-receiving regions of the second light-receiving element for a sub beam;
a second adding part for adding the first sub beam electrical signal output by the other pair of light-receiving regions of the first light-receiving element for a sub beam and the second sub beam electrical signal output by the other pair of light-receiving regions of the second light-receiving element for a sub beam; and
a first differential operation part for performing a differential operation on electrical signals output by the first and the second adding parts, respectively.

21. An optical recording/reproducing apparatus according to claim 18, wherein the error signal detection unit includes a second preliminary focus error signal detecting portion which detects second preliminary focus error signal that is the electrical signal based on the main beam reflected by the first or the second optical recording medium. having:
a third adding part for adding the main beam electrical signals output by the other diagonal pairs of light-receiving regions of the light-receiving element for a main beam; a fourth adding part for adding the main beam electrical signals output from the other pair of light-receiving regions of the light-receiving element for the main beam; and
a second differential operation part for performing a differential operation on electrical signals output by the third and fourth adding parts, respectively.

22. An optical recording/reproducing apparatus according to claim 21, wherein the error signal detection unit further includes a third preliminary focus error detecting portion which detects a third preliminary focus error signal by adding the first and the second preliminary focus error signals, having a preliminary focus error signal adding portion for adding the first preliminary focus error signal output by the first preliminary focus error signal detecting portion and the second preliminary focus error signal output by the second preliminary focus error signal detecting portion.

23. An optical recording/reproducing apparatus according to claim 22, wherein the switch is controlled so as to select the first preliminary focus error signal in the case of the first optical recording medium and to select the second or the third preliminary focus error signal in the case of the second optical recording medium as the focus error signal.

24. An optical recording/reproducing apparatus according to claim 12, wherein the diameter of the spots of the two sub beams imaged on a surface of the optical recording medium in the radial direction of the optical recording medium is 2.5 times or more of the diameter of the spot of the main beam in the same direction.

25. An optical recording/reproducing apparatus according to claim 14, wherein the first optical recording medium is a DVD−RAM or an optical recording medium having a physical track pitch equivalent to that of the DVD−RAM and wherein the second optical recording medium is a DVD±R/RW, DVD−ROM or an optical recording medium having a physical track pitch equivalent to that of the DVD±R/RW or DVD−ROM.
